(19) United States
(12) Patent Application Publication
(10) Pub. No.: US 2001/0039552 A1
(43) Pub. Date: Nov. 8, 2001

(54) Method of reducing the size of a file and a data processing system readable medium for performing the method

(76) Inventors: Tom E. Killi, Oslo (NO); Ingvar Nilsen, Torpo (NO)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/898,669

(22) Filed: Jul. 3, 2001

Related U.S. Application Data
(62) Division of application No. 09/776,331, filed on Feb. 2, 2001.
(60) Provisional application No. 60/180,356, filed on Feb. 4, 2000.

(51) Int. Cl. G06F 15/00

(52) U.S. Cl. 707/500; 707/526

(57) ABSTRACT

Novel methods, data processing system readable media, and software program products overcome at least some problems related to developing and using training materials. In one set of embodiments, a course developer can use a novel development tool to quickly and easily generate electronic training guides without highly specialized training. A person that can work with conventional software applications commonly used by businesses should be capable of developing electronic training guides with little, if any, formal training. In another set of embodiments, a user of an electronic training guide can experience more graphical and easy to understand instructions for performing operations within a software program for which the electronic training guide is directed. The user does not have to rely mostly on textual instructions from a manual or a help screen. The ability to retain the subject matter of the electronic training guide should be better than with conventional training materials.

### RELATED PROGRAMS

This application claims priority under 35 U.S.C. § 119(e) to U.S. patent program No. 60/180,356 entitled “Method and System For Proactively Guiding a User Through an Object Based Program” by Killi filed Feb. 4, 2000, which is assigned to the current assignee hereof and is incorporated herein by reference.

### FIELD OF THE INVENTION

This invention relates in general to methods, data processing system readable media and software program products, and more particularly, to methods and data processing system readable media, and software program products for creating and using electronic training guides.

### RELATED ART

The functions that software programs can perform are ever increasing with each revision of existing product and new products. Learning and remembering all the new functions of a software program can be difficult. Traditionally, manuals have been used to describe functions and how to use them. While manuals are usually thorough in their treatment of a subject, they tend to be very large, whether in a hard copy or soft copy version, and may take a long time to read all the details of the function. In many instances, the user may only want to learn how to perform a function rather than learn every possible way to use or call the function and its derivatives. The manuals tend to be very text intensive.

Many software programs are sold with help files as part of the program. The help screens mostly rely on text explanation of the functions. Typically, there are no or little graphics showing how to use a function. A user may retain less information regarding a function and its use because of the lack of graphical assistance.

Some programs have a “show-me” feature as part of the program, but it may be limited. For example, in Microsoft Word 97™ made by Microsoft Corporation of Redmond, Wash., the show-me feature starts a sequence for performing a function. The show-me feature appears to stop at first level of pull down screens. Text can be used for the rest of the explanation of the feature. For functions that are at lower levels, the user must follow the text. In one example related to Microsoft Word 97™ made by Microsoft Corporation of Redmond, Wash., a user may want to change line numbering from continuous line number to restarting line numbering for each page. The “show me” function takes the user to the page set-up screen, which is a first level of the pull down screen under “File.” From there, the user must rely on text instructions. The show-me features are limited in their showing of features that are many levels down.

### SUMMARY OF THE INVENTION

Novel methods, data processing system readable media, and software program products are described that overcome problems described previously. In one set of embodiments, a user of an electronic training guide can experience more graphical and easy to understand instructions for performing operations within a software program for which the electronic training guide is directed. The user does not have to rely mostly on textual instructions from a manual or a help screen. Also, the user can seen views that correspond nearly exactly to corresponding views within the software program. The user may be more likely to retain what he or she has learned because the electronic training may rely more on graphical representations than text.

In another set of embodiments, a course developer can use a novel development tool to quickly and easily generate electronic training guides. The course developer does not need to be a computer specialist to generate the training guides. A person that can work with conventional software applications, such as word processing applications and presentation-oriented application (e.g. Microsoft PowerPoint™ or the like) should be capable of developing electronic training guides with little, if any, formal training. If needed, the electronic training guides can be generated within minutes and sent to a user of a software program at a remote site.

In one embodiment, a method of creating an electronic training guide for using a first software program (target software program for the electronic training guide comprises capturing a screen, adding text, and assembling the electronic training guide. When capturing the screen, a second software program (a development tool) can be used to capture the screen from the first software program to form a screenshot. The second software program can be used to add the text corresponding to the screenshot, and to assemble the electronic training guide that includes at least part of the screenshot and corresponding text. The electronic training guide is at least part of a third software program or a file that can be used with the third software program. This embodiment can allow a course developer to quickly and easily creating an electronic training guide.

In another embodiment, a method of creating electronic training guides for the first software program comprises recording a screenshot from a screen of the first software program and creating at least two different electronic training guides using the screenshot. The different electronic training guides include any two or more of: a first lesson, a second lesson that is different from the first lesson, a test, and an executable file. In one particular embodiment, the first lesson is referred to as a tutor, and the second lesson is referred to as a web guide or a soft guide. A course developer may form different types of electronic guides at different levels of detail or using different teaching materials.

In still another embodiment, a method of guiding a user in using a first software program comprises accessing a second software program and displaying a sequence of views using the second software program. The second software program may be an electronic training guide. In this embodiment, the second software program includes information to help guide the user to perform an operation using the first software program. The sequence of views are in an order in which acts would be performed by a user if he or she is using the first software program. Each view within the sequence of views includes at least a portion of a corresponding view within the first software program. That view within the sequence of views is substantially the same as the at least a portion of the corresponding view in the first software program. This embodiment can allow a user to be shown every screen that he or she will see in order to perform an operation.

In still another embodiment, a method of training a user of a first software program comprises accessing a second software program including a test and taking the test. The test is to test the user's ability to perform at least one operation of the first software program. At least one view is displayed to the user during the test and is substantially similar to at least one corresponding view in the first software program. During the test, the user performs substantially the same acts as the user would if performing the operation(s) using the first software program. The ability to test allows a course developer to determine at what level a user needs to understand the operation(s) being tested.

In yet another embodiment, a method of guiding a user in using a first software program comprises accessing a first software program, accessing a second software program, performing a first act using the first software program and performing a second act using the second software program. The second software program includes information to help guide the user in using the first software program. The second act can be performed while the first software program resides in an active window. A user can access the second software program without having to leave or deactivate the first software program. Many readers should appreciate that this can be a significant advantage over conventional switching back and forth between windows where only one window can be accessed via a keyboard or electronic pointing device (e.g., mouse, track ball, or the like).

Other different embodiment include a data processing system readable storage medium having code embodied therein. The code includes instructions executable by a data processing system. The instructions are configured to cause the data processing system to perform any one or more of the methods or portions of the methods previously described.

In another embodiment, a software program product can be used for creating an electronic training guide for using a first software program. The software program product comprises a screen capture module, an editor module, and an assembly module. The screen capture module can be adapted to capture a screen seen when using the first software program. The editor module can be adapted to add text related to the captured screen. The assembly module can be adapted to assemble the captured screen and text to form at least part of a second software program or a file that can be used with the second software program. Other modules may be present within the software program product.

### BRIEF DESCRIPTION OF THE DRAWINGS

The present invention is illustrated by way of example and not limitation in the accompanying figures, in which like references indicate the same elements, and in which:

FIG. 1 includes a schematic representation of a data processing system in accordance with an embodiment of the present invention;

FIG. 2 includes an illustration of a high-level representation for creating, distributing, and using a training guide in accordance with an embodiment of the present invention;

FIGS. 3-14 include illustrations of interfaces and icons that may be used by a course developer in accordance with embodiments of the present invention;

FIG. 15 includes an illustration of a block diagram representing an exemplary structure of a course;

FIGS. 16-A and 16-B include a process flow diagram and a data flow diagram for creating lesson file;

FIG. 17 includes an illustration of a data structure for a lesson file;

FIG. 18 includes an illustration of a view that can be seen when cloning a file using the development tool;

FIG. 19 includes an illustration of a process flow diagram and a data flow diagram for creating a soft guide;

FIG. 20 includes an illustration of a view that can be seen when creating a microguide from a corresponding soft guide;

FIG. 21 includes an illustration of a process flow diagram and a data flow diagram for creating a microguide;

FIG. 22 includes an illustration of a process flow diagram and a data flow diagram for creating a course;

FIG. 23 includes an illustration of a view that can be seen when building a course;

FIG. 24 includes an illustration of a process flow diagram and a data flow diagram for building a course;

FIG. 25 includes an illustration showing different types of files and whether they are created before building or during building;

FIGS. 26-33 include illustrations of views seen by a user of electronic training guides in accordance with embodiments of the present invention; and

FIGS. 34 and 35 includes timing diagrams illustrating activity within a target software application and an electronic training guide based on keystrokes of a user.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Course developers and users of training materials may use methods, data processing system readable media, and software program products described herein to allow quick and easy creation and deployment of electronic training guides that may be significantly easier to understand compared to conventional training materials. If the course developer is able work with conventional software applications commonly used by businesses, such as word processing applications and presentation-oriented applications (e.g. Microsoft PowerPoint™ or the like), he or she should be capable of developing electronic training guides with little, if any, formal training. If needed, the training guides can be generated within minutes and sent to a user of a software program at a remote site. The user of an electronic training guide can experience more graphical and easier to understand instructions for performing operations within a software program for which the electronic training guide is directed. The user may be more likely to retain what he or she has learned because the electronic training may more closely replicate the software program that is the subject of the training guide. The present invention is defined by the appended claims and is better understood after reading the description of embodiments that follow.

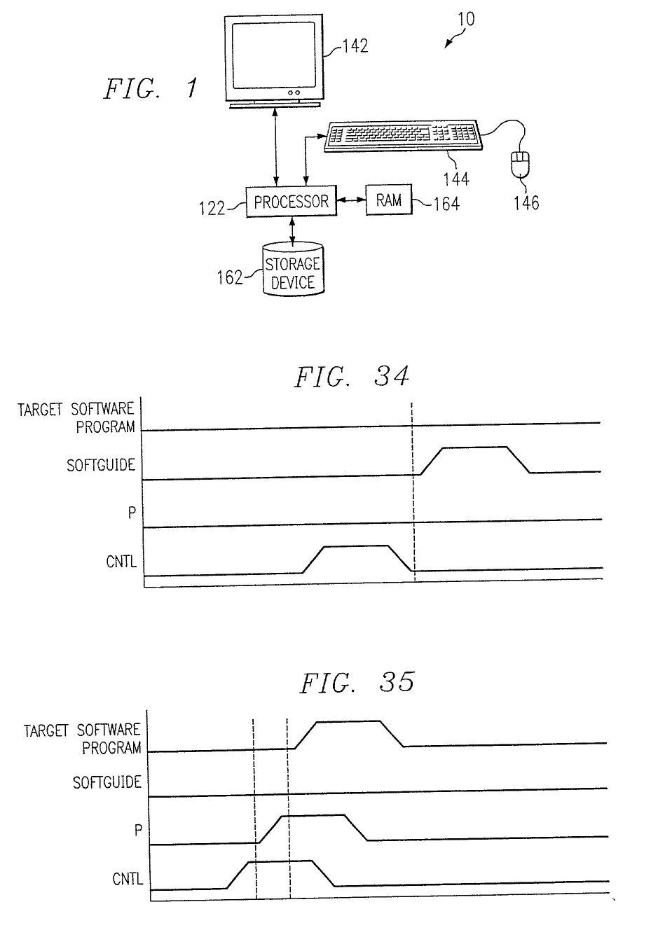

A software program (hereinafter referred to as the “development tool”) can be used to create, preview, distribute, or use an e-training guide. The training guide may be a stand alone software program or may be at least one file used in conjunction with a software program to provide assistance to a user of a different software program to which the training guide is directed (target software program). The development tool or a training guide may include information that is processed by a data processing system 10 as shown in FIG. 1. The data processing system 10 includes a processor, which is bi-directionally coupled to input/output devices including a monitor 142, a keyboard 144, and an electronic pointing device 146 (e.g., a mouse, a track ball, or the like). The electronic pointing device 146 can be connected to the keyboard 144 as shown in FIG. 1 or may be connected to the processor 122 as a separate input/output device (not shown). The processor 122 is bi-directionally coupled to a storage device 162 (e.g., a hard disk, floppy diskette, CD-ROM, or other nonvolatile memory) and random access memory (RAM) 164 (e.g., static random access memory, dynamic random access memory, or the like).

The information within the development tool and the training guide are typically in the form of code that is embodied within a data processing system readable medium. The code includes instructions that are executable by the data processing system 10. The instructions are configured to cause the data processing system 10 to perform a method as defined by the code. The methods that the code can carry out are further explained below.

To use the development tool or the training guide, the processor 122 typically reads the file(s) of the development tool or training guide that can be within the storage device 162 and loads it into RAM 164. The development tool or stand-alone version of a training guide typically includes instructions for carrying out a method. If a training guide is not a stand alone software program, it may be used in conjunction with a different training guide or other software application having executable files with instructions. The processor 122 principally controls a software program during its execution.

The system 10 can be in the form of a personal computer, a server-client relationship, or part of a network. A client typically refers to an individual workstation or computer that is operated by a user (human). In a server-client relationship or network, the monitor 142, the keyboard 144, and the pointing device 146 may be at a location where the user works, and the processor 122, the storage device 162, and RAM 164 may be part of a server at a remote location. For the server-client relationship or the network, the client may include its own processor, RAM, storage device, any combination thereof, or the like but are not shown in FIG. 1.

The data processing system 10 and the user of development tool or training guide may communicate to each other by the use of requests, commands, or otherwise sending and receiving information. Communications from the user are converted to signals (electronic, optical, or the like) that the data processing system 10 can understand. The data processing system 10 to the user are converted from signals to an image or other format the can be understood by humans.

The system 10 may operate using a Windows™, MacOS™, OS/2™, Linux, Unix™ or other similar operating system. If the system 10 is part of a personal computer, the personal computer may operate using a personal computer version of any those operating systems. If at least part of the system 10 resides on a server, the server may operate using a server version of any of those operating systems.

As shown, the system 10 includes at least one software program, which is described in more detail later in this specification, that may be executed by processor 122 within the system 10 as a series of data processing system-executable instructions. These instructions may reside, for example, in RAM 164 of the system 10. Alternatively, the instructions may be contained on storage device 162 embodied within a data processing system readable medium, such as a computer diskette. Alternatively, the instructions may be stored on a magnetic tape, conventional hard disk drive, electronic read-only memory, optical storage device, or other appropriate data storage device.

In an illustrative embodiment of the invention, the computer-executable instructions may be lines of compiled C⁺⁺, Java, Object Pascal, or other computer language code. Architectures other than the one shown may be used. FIGS. 3-33 further illustrate, in the forms of diagrams, flow charts, and screen views the portions of structures of such software programs.

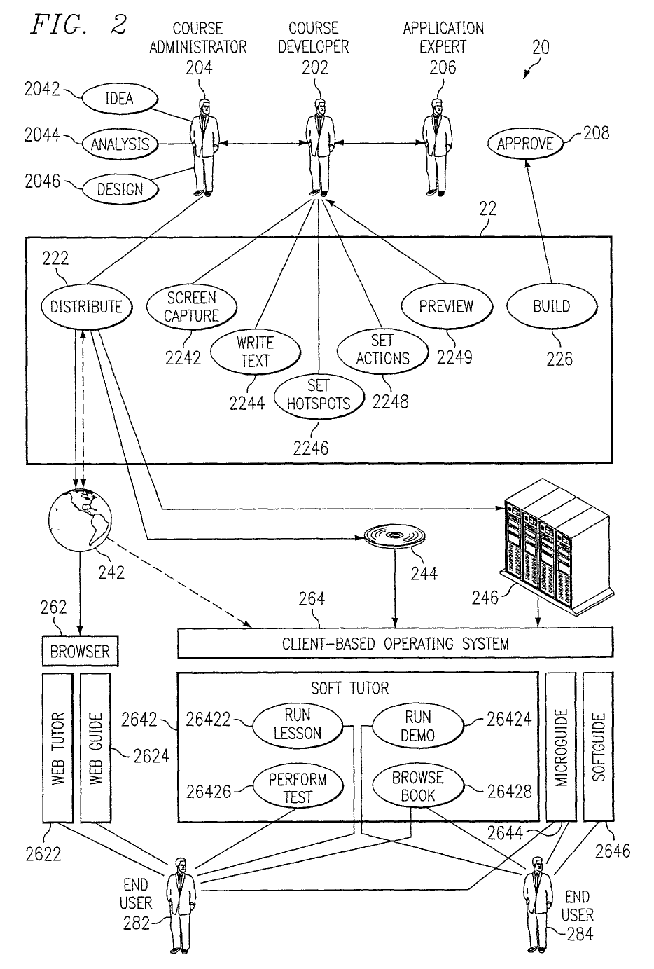

FIG. 2 includes an illustration of high-level diagram illustrating the creation, preview, distribution, and use of the training guides in accordance with an embodiment of the present invention. Note that embodiments of the present invention may include a development tool used to create, preview, and distribute the training guide, and the training guide itself.

In many cases, a course developer 202 and a course administrator 204 interact with one another in creating a training guide. The course administrator 204 can provide the course developer 202 with an idea 2042 and design 2046 and other content of a target software program. The target software program may include nearly any software program including Microsoft Word, Adobe PhotoShop, Lotus Notes, internally generated or custom software programs, or the like. The course developer 202 can access the target software program of the training guide. Many of the actions during the creation of the training guide are generally represented within block 22.

As will be described in more detail later, the course developer 202 performs a screen capture function 2242 using a screen capture module, writes text 2244, sets “hotspots” 2246, sets actions 2248 needed to proceed with the training guide, and performs a preview 2249 of the training guide generated. As used herein, a “hotspot” includes a designated area of a screenshot where an arrow, hand, or other graphical indicator is pointing. The hotspot designates where an end user can perform an action to proceed within the training guide.

After the preview, the course developer 202 may perform additional screen captures or edit the test, hotspot notations, or action keys using an editor module as needed until the course developer 202 is satisfied with the training guide. The course developer 202 may consult with the course administrator 204 for an analysis 2044 or to get further inputs on ideas 2042 or the design 2046.

If the course developer 202 and course administrator 204 are satisfied with the training guide, the course developer 202 may perform a build function 226 using an assembly module that assembles the training guide that can be used by an end user 282 or 284. An application expert 206 may review and approve 208 the training guide. If disapproved, the application expert 206 may give the course developer 202 or the course administrator 204 feedback for changes. The course developer 202 may make further changes to the training guide. If approved, the training guide is forwarded to the course administrator 204 for distribution 222.

The course administrator 204 may determine the time and method for distributing 222 the training guide. The training guide may be distributed whole or in part via the Internet 242, a CD ROM 244, or a network 246. In one embodiment, a client operated by end user 282 may use a web version of the training guide. End user 282 may access the site for the training guide using a conventional browser, such as Internet Explorer™, Netscape Navigator™, or the like. End user 282 may have access to the web version of the tutor (web tutor 2622) or the web version of the graphical guides (web guide 2624).

In still another embodiment, the training guide may be downloaded from the Internet 242, CD ROM 244, or network 246 to a client. End user 282 may access the Internet 242 to receive a web distributed copy of the training guide. After downloading, end user 282 may uses his or her client-based operating system 264 in running the downloaded copy of the training guide.

Alternatively, the training guide software program may reside as a file or files on the CD ROM 244 or a network server 246. End user 282 or 284 may copy the training guide from the CD ROM 244 or network server 246. The copying may be performed using a client-based operating system 264. Note that each end user 282 or 284 typically operates a client having its own operating system. In still another embodiment (not shown), the training guide may run on the client of end user 282 or 284, but only accesses files as needed from the CD ROM 244 or network 246. This embodiment may be useful if the training guide (and all it associated files) is large and the client has limited space on the storage device 162.

End user 282 or 284 may use the soft tutor 2642, soft guides 2646, or microguides 2644. With the tutor 2642, the end user 282 or 284 can run a lesson 26422, run a demonstration 26424, perform a test 26426 (tests the end user's knowledge of what is taught in the training guide), or browse the book 26428, as the training guide may be displayed to end user 282 or 284 as a book in one embodiment. A soft guide 2646 includes a graphical representation of acts that may be performed to accomplish a task within the target software program. The soft guide 2646 typically includes a routine file, where the routine file is not an executable file. From a content standpoint, a microguide 2644 can have substantially the same content as the soft guide 2646. However unlike a soft guide 2646, a microguide 2644 can be a stand-alone executable file of the soft guide 2646. The web tutor 2622 can allow substantially the same functionality as tutor 2642, and the web guide 2624 can allow similar functionality as the soft guide 2646. Differences between the web guide 2624 and the soft guide 2646 will be described later.

Skilled artisans appreciate that the embodiments shown in FIG. 2 can be varied in a nearly unlimited number of ways. For example, the functions of the course developer 202, course administrator 204, or application expert 206 may performed by more or fewer people. For example, all functions in block 22 could be performed by the course developer 202. In still another embodiment, the text writing function 2244 may be performed by a technical writer (not shown) separate from the course developer 202, the course administrator 204, and the application expert 206.

In still another embodiment, the end user 282 or 284 may receive fewer parts. The end user 284 may be having problems learning how to perform a function within a target application. More specifically, the end user 284 may be having problems with a cut and paste function with a word processing application (target software program). Course developer 202 may quickly generate the appropriate screenshots, generate a microguide, and send it to end user 284 within an hour of receiving a call from the end user 284. The flexibility of the tool and its generation of training materials relatively quickly and easily is advantageous.

Before turning to a description regarding using the development tool, some of the interfaces are described to allow the course developer 202 and potentially others to create a training guide. The development tool includes one or more of the following interfaces: a lesson designer interface, a book designer interface, a file manager interface, an object manager interface, and a page manager interface. In alternate embodiments, more or fewer interfaces may be used.

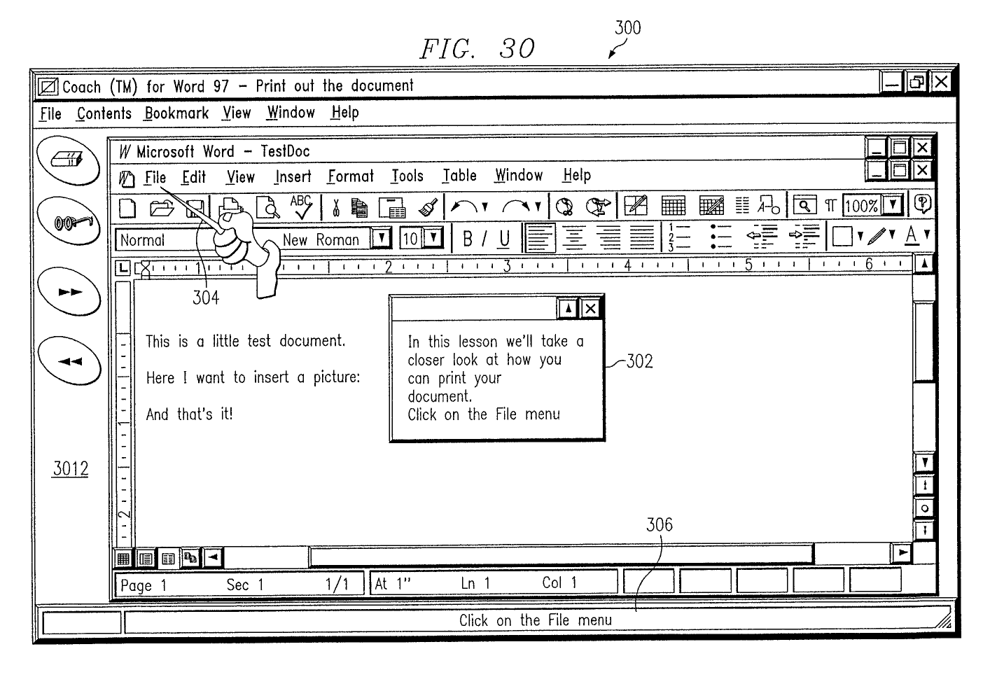

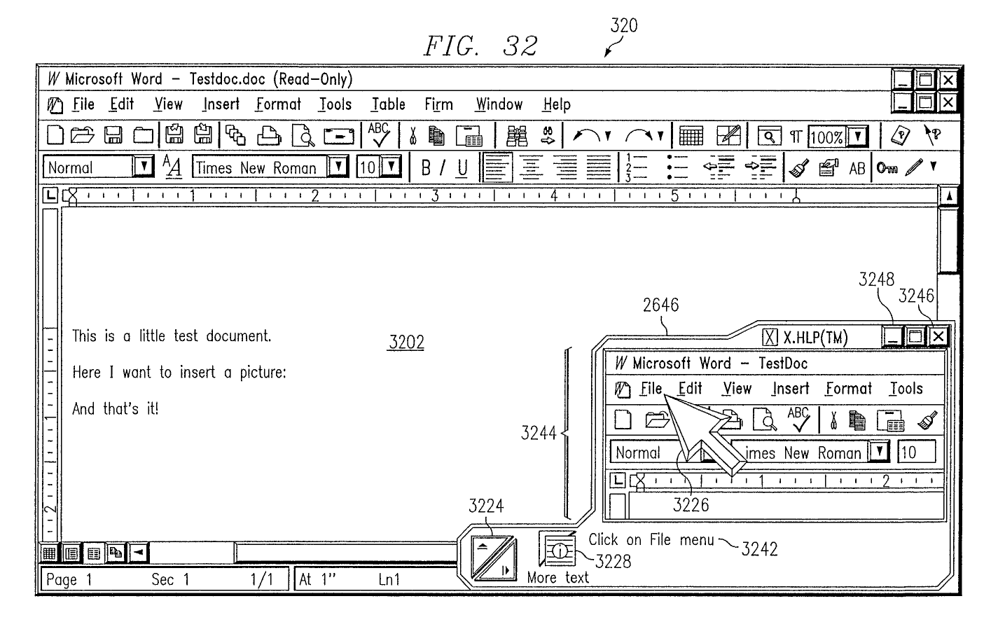

FIG. 3 includes a view 30 available to a course developer 202 when using the lesson designer interface. For the lesson designer interface, functions available to a lesson designer may be accessed through the menu bar 32 or through icons within a tool bar 34. The view 30 further includes a text line 36, which is where text can be added that is displayed to the end user 282 or 284 as line 306 in FIG. 30 in tutor 2622 or 2642 or as the text portion 3242 in FIG. 32 of the guide 2624, 2644, or 2646. Portion 38 occupies about 70 percent of view 30 and generally corresponds to what the end user 282 or 284 will see when using the tutor 282 or 284.

When using the pull-down menus from the menu bar in FIG. 3, the categories of functions for the interface include file, edit, view, course, tools, and help.

The file category includes the following functions.

New course: used to create a new course.

Open course: used to open an existing course.

Save: saves modified files in a course.

New lesson: creates a new lesson in an existing course.

Delete lesson: deletes a lesson that is open in an existing course.

Clone lesson: copies an existing lesson, test, or guide and optionally transforms it into a different lesson, test, or guide.

Course properties: opens the course properties of a course that is open.

Lesson properties: opens the lesson properties of a lesson that is open.

Microguide: generates self executing version of a corresponding soft guide.

Export resources: exports text or images from a lesson that is open.

Import resources: imports existing courses, text or images to a lesson that is open.

Exit: closes the development tool.

The edit category includes the following functions.

New page: creates a new page in a lesson that is open.

Delete page: deletes a page that is open in a lesson.

Move page: moves a page in a lesson.

Save image of page: saves an image of an open page in a lesson.

Replace image of page: replaces an image in an open page in a lesson.

Insert action bar: inserts a hotspot in an open page in a lesson.

Insert drag-and-drop hotspot: inserts a drag-and-drop hotspot in an open page in a lesson.

The view category includes the following functions.

Next page: opens a next page in a lesson that is open.

Previous page: opens a previous page in a lesson that is open.

First page: opens the first page in a lesson that is open.

Last page: opens the last page in a lesson that is open.

Select page: move to a specific page in a lesson that is open.

Object properties: displays object properties.

File management: displays the file manager interface.

Update file management: updates the contents of the file manager with contents of a course that is open.

Hint in file management: turns hints on or off in the file manager.

Panel: displays and hides the text panel for the lesson.

Notes: opens a notes dialog box. A note can be a page annotation.

Keyword: displays a dialog box for registering keywords.

Related topics: displays a related topics tool.

The course category includes the following functions.

Preview lesson: runs a lesson that is open in the lesson designer interface.

Build course: builds a course.

Run soft guide: runs a soft guide lesson that is open in the lesson designer interface.

The tools category includes the following functions.

Register screen F6: alternative key for starting a screenshot camera. After registering screens is activated, the processor 122 will minimize a view for the development tool and prepares for screen registration.

Stop registering: stops the registration process (i.e., stops the screenshot camera).

Book designer: opens the course developer 202 with the book designer interface view.

Settings: opens a settings dialog box.

The help category includes the following functions.

Contents F1: displays contents of topics for which assistance is available.

Upgrade: requests information regarding the client and the registration code for the development tool

About: contains a version number of the development tool.

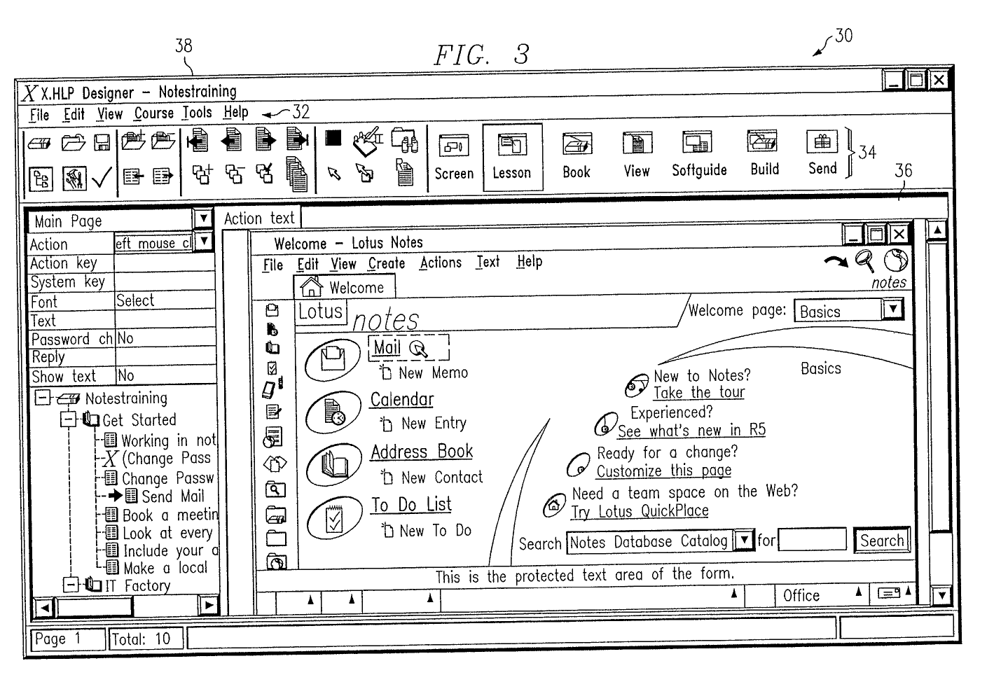

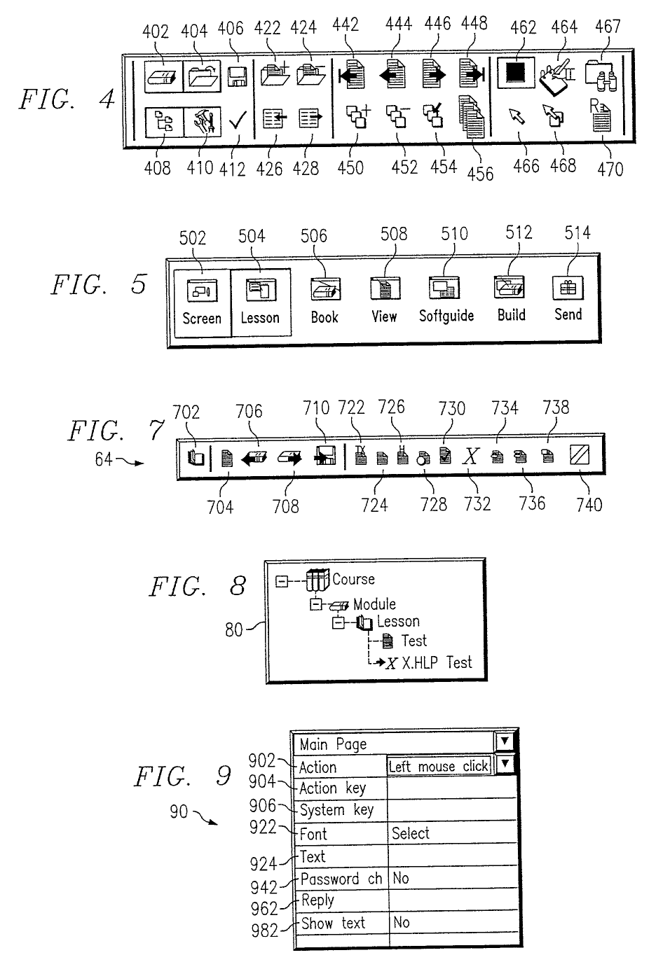

In one embodiment, the lesson designer interface includes a tool bar 34 having a course tool bar portion as shown in FIG. 4 and a wizard tool bar portion as shown in FIG. 5. The course tool bar portion includes numerous icons representing various functions, many of which have corresponding menu-bar functions. A new course icon 402 can be used to create a new course file. Note that another course file may be open when a new course file is created. If this occurs, the course developer 202 may be requested whether he or she wants to save changes in the course that is open. An open course icon 404 can be used to open an existing course file. A save course icon 406 can be used to save a lesson or course file. A course overview and file manager icon 408 can be used to display or hide the course overview and file manager tool. An object properties icon 410 can be used to display or hide the object properties tool. An update file manager icon 412 can be used to update the file manager so that it displays the current contents of a course file, for example after moving lessons to the file manager.

In another section of the course tool bar portion, the new lesson icon 422 can be used to insert a new lesson into an existing course file. The course developer 202 can create a new lesson while another lesson file is open. If that occurs, the course developer 202 may be asked if he or she wants to save changes in the lesson that is open. A delete lesson icon 424 can be used to delete a lesson that is open. An import image icon 426 can be used to import an image into the current page of an open lesson. An export image icon 428 can be used to export an image from the current page of an open lesson.

In still another section of the course tool bar portion, the first page icon 442 can be used to move to the first page in a lesson. The previous page icon 444 can be used to move to a previous page in a lesson, and a next page icon 446 can be used to move to a next page in a lesson. A last page icon 448 can be used to move to the last page in a lesson. An add new page icon 450 can be used to create a new, blank page in a lesson. The blank page can be used for importing graphics, for example, from an external source in one embodiment. A delete active page icon 452 can be used to delete an active page from a lesson. A move page icon 454 can be used to move pages within a lesson. A select page icon 456 can be used to go to a specific page in a lesson. In a final section of the course tool bar portion, a show panel icon 462 can be used to display or hide the text panel. A notes icon 464 can be used to display or hide the dialog box for entering notes into a lesson. A register keyword icon 467 can be used to display or hide a dialog box for registering keywords for a lesson. A hotspot icon 466 can be used to insert a hotspot into a page in a lesson. When the course developer 202 selects this icon, a pointer of a pointing device (e.g., mouse, track ball, etc.) changes into a cross. The course developer 202 can use the cross to drag a hotspot onto a page image. A drag-and-drop hotspot icon 468 can be used to define a hotspot in which the end user 282 or 284 of the lesson can drag an object or the like from one place to another. A related topic icon 470 can be used to for registering related topics for a lesson. When building the course, lessons that are logically related to each other will then be linked together in accordance with each lesson's related topic(s).

The wizard tool bar portion, as seen in FIG. 5, can be organized to lead a course developer 202 through typical steps when creating a training guide. A screen icon 502 can be used to capture a screen and insert it into a lesson file. A lesson icon 504 can be used to insert a hotspot, enter text, etc. into a lesson. A book icon 506 can be used to open the course developer 202 to the book developer interface. A view icon 508 can be used to run an open lesson in runtime for testing. A soft guide icon 510 can be used to build and run an open soft guide topic in runtime for testing. A build icon 512 can be used to compile the training guide. A send icon 514 can be used to send a training guide, together with associated file (or files), to a server, a CD ROM, or other designation.

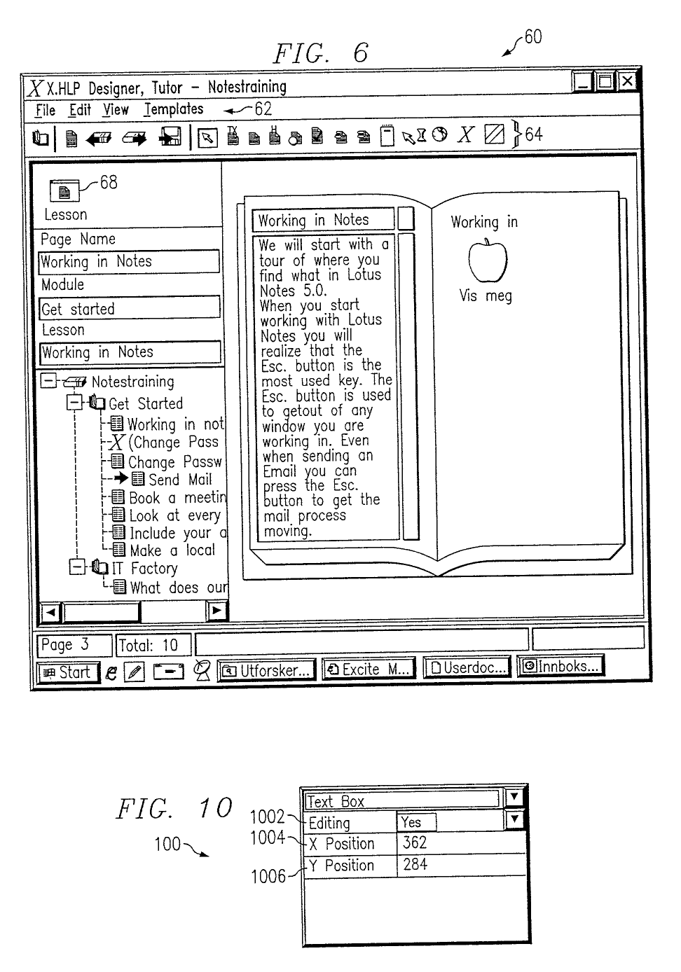

FIG. 6 includes a view 60 of the book designer interface. For the book designer interface, functions available to the course developer 202 may be accessed through the menu bar 62 or through icons within a tool bar 64. The course developer 202 may return to the lesson designer interface by activating the lesson icon 68. When using the pull-down menus from the menu bar, the categories of functions for the interface, include file, edit, view, and templates.

The file category includes the following functions.

New page: creates a new book page that may be placed at the end of a book.

Move page: moves a book page to another place in a book.

Save page: saves a book page.

Delete page: deletes a book page that is open.

Import/export text: exports or imports text to a document for a word processing application (separate software program).

Icons: opens an icon dialog box, in which book icons (an apple, etc.) can be changed.

Close: closes the view for the book designer interface and changes to the view for the lesson designer interface.

The edit category includes the following functions.

Undo: undo the operation previously performed.

Redo: redo the operation previously performed.

Copy: copy from a book page to a clipboard.

Cut: copies selected material to a clipboard and deletes it from the original source.

Paste: paste from a clipboard.

Delete page link: deletes a page link between a lesson and a book page that is open.

The view category includes the following functions.

Edit book: displays the view for the book designer interface in design mode.

Test finished book: displays a book as it will appear to the end user 282 or 284.

Next page: opens a next book page.

Previous page: opens a previous book page.

Go to page: opens a dialog box in which a specific book page is selected.

The templates category includes the following functions.

Open template: opens an existing template page.

Save template: saves an active page.

In one embodiment, the book designer tool bar 64 may include numerous icons representing various functions, many of which have corresponding menu-bar functions. A test book icon 702 can be used to test a book. The icon can be used to change into “Edit book” when a book is running in test mode. A new page icon 704 inserts a new book page after the current page of a book. A previous page icon 706 can be used to move to a previous page in a book. A next page icon 708 can be used to move to a next page in a book. A go-to-page icon 710 can be used to go to a specific page.

A text icon 722 can be used to insert a text object in a book. A text object can be a standard text object. The book designer interface may be configured to not allow different fonts or font sizes in the same text box. Some operations for text objects include the following.

Font: The course developer 202 can select which font and font size he or she wants to use, as well as which styles.

Back: Places an object behind all other objects on a page.

Front: Places an object in front of all other objects on a page.

Delete: Deletes a selected object and its contents from a page.

All text objects may have a font property. All objects, whether text or graphics, may allow back, front and delete operations.

An image icon 724 can be used to insert a graphic in the book. When an object has been inserted, the course developer 202 may select a graphic by double-clicking on it. A Windows Bitmap™ format (BMP) is an example of an acceptable format. A shortcut menu for graphical objects includes the following options.

Go to page: The course developer 202 may select which page the book will move to when the end user 282 or 284 clicks on a graphical object.

File: The course developer 202 may select a graphic file.

Stretch: The course developer 202 may change a size of an object.

Save image: The course developer 202 can save an image in a graphical object to a Windows Bitmap™ file.

Transparent: The color in the pixel in the lower left-hand corner can be selected as a transparent color. The part of the graphic that has this color can become transparent.

A hypertext icon 726 can be used to insert hyperlinks in the book. A property may include a go-to-page finction. A lesson icon 728 can be used to insert a lesson symbol into a book page. To link a lesson, the course developer 202 may perform one of the following. If the course developer 202 desires to link a lesson to a book page, he or she may drag a lesson from file manager of the development tool onto the book page. If course developer 202 only wants to link a lesson to a symbol (for example if there are several lessons on one page), he or she can drag the lesson from file manager to the desired lesson symbol. When the course developer 202 has linked a lesson to the lesson symbol, he or she can remove the link by clicking “Remove connection” on a shortcut menu. If the course developer 202 wants to remove a link between a whole page and a lesson, he or she may use a “delete page” from the edit menu.

A test icon 730 can be used to insert a test symbol into a book page. A test can be linked to the test symbol in substantially the same way as lessons are linked to the lesson symbol. A soft guide icon 732 can be used to insert a soft guide symbol to (one word “into”) in a book. A soft guide can be linked in substantially the same way as lessons and tests. A tip icon 734 can be used to insert a symbol for a tip in a book. The course developer 202 can enter tips by double-clicking the symbol or by selecting “tips” from a shortcut menu. A more info icon 736 can be used to insert a symbol for more information into a book. The course developer 202 may enter more information by double-clicking icon 736 or by selecting “info text” from a shortcut menu. A related topics icon 738 can be used to insert a symbol for a related topic in a book. The course developer 202 should check to determine whether there are related topics, if there is no automatic check. An effects icon 740 typically is applied on a page-by-page basis. A default page effect in the book may include having pages in the book appear to be turned similar to the pages in a hardback book. The course developer 202 can use the icon 740 to select other effects. Effects are selected from the shortcut menu. In addition to browse a book in usual way (the way a hardback book would be browsed), the icon 740 can be used to select at least two other effects that are described briefly.

Without effects: If the course developer 202 selects “without effects,” the pages in a book will change without the usual browsing effect (“flipping” pages). This transition between views may be desired if the course developer 202 is designing the book to be used as part of a presentation. In one embodiment, effects only appear when an end user 282 or 284 browses to a page with effects.

Gradual: The graphic on a page appears gradually.

A program start icon (not shown in FIG. 7) can be used to enter as a symbol for a program start that enables a end-user 282 or 284 to run a program or a document from the tutor book. For its properties, the course developer 202 can select which program or document can be run from the book. The course developer 202 can also select whether the end user 282 or 284 should confirm that the document or program is to be run.

The development tool can further include a file manager interface as seen in view 80 in FIG. 8. The file manager interface can give an overview of course series, courses, modules and lessons, and the way in which these are organized in relation to each other. In FIG. 8, an entry at the course level is entitled “Course,” an entry at the module level is entitled “Module,” and an entry at the lesson level is entitled “Lesson.” At course, module, and lesson levels, there may be shortcut menus for quick overviews and processing of the contents of the course. These are described briefly here.

Course level: The course developer 202 can export and import sequence notes for the complete course. The function can be useful when a course is being quality assured. The course developer 202 can also export and import panel text and action text for all lessons in the course at the course level. This may be useful when translating (between linguistic languages) and spell checking the course. The name of the course can be changed at the course level.

Module level: The course developer 202 can export and import sequence notes, panel text and function text at the module level.

Lesson level: The course developer 202 can find information on a lesson selected. He or she may also have a lesson property option. For example, the course developer 202 can change a lesson to a soft guide topic or a test, and vice versa.

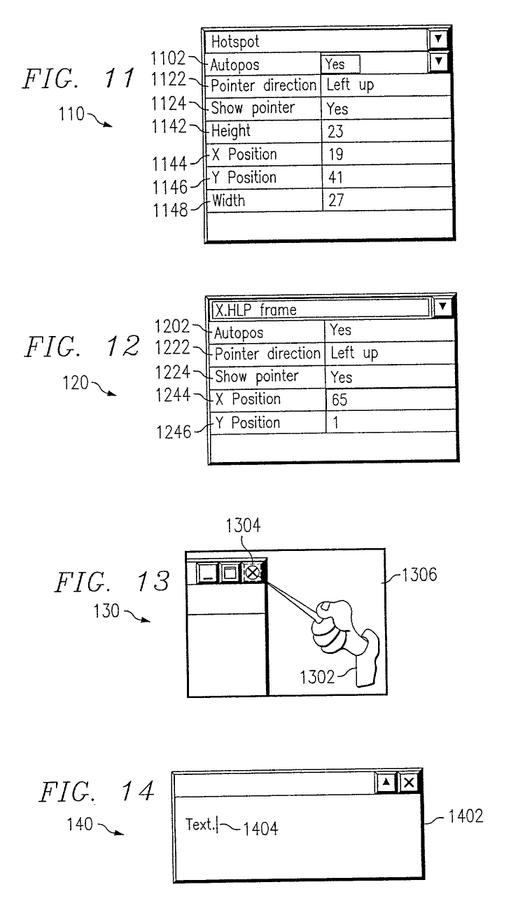

An object manager interface allows the course developer 202 to create, text edit, size, position, or otherwise manipulate an object for a training guide. The object manager interface includes a pull-down menu to select a main page object manager, a text box (panel) object manager, hotspots object manager, and a soft guide frame object manager. FIG. 9 includes a view 90 of the main page object manager, which can be used to define what the end user 282 or 284 should do in order to proceed in a lesson. The action pane 902 describes an action that the end user 282 or 284 may perform to proceed in a lesson. Usually, a feature of an electronic pointing device (mouse, track ball, or the like) can be used. The feature may include a left-click pad, a right-click pad, a scrolling wheel, merely moving the pointer of the electronic pointing device, or the like. Specific actions with a pointing device may include a click, double-click, or the like. Many other types of actions are possible. A default value in this field may be a single click of the left-click pad.

An action key pane 904 can be used to define an action key that can be used to proceed in a lesson. An action key can be nearly any key on keyboard 144 and includes letter keys, function keys, numbers, arrows, page up, page down, delete, insert, and the like. A system key pane 906 can be used to define a key that can be used in conjunction with an action key. The system keys include CTRL, ALT, and SHIFT. When a system key is specified in pane 906, the combination of the system key in pane 906 and the action key specified in pane 904 is used to proceed in a lesson.

For some pages, text within a pane 924 may be sent to end user 282 or 284, where end user 282 or 284 is to respond. For example, when printing only page 1 from a document, the end user may be instructed to type “1.” The course developer 202 may enter “Type ‘1’ here” in pane 924, and may enter “1” within the reply pane 962. In order for the end user 282 or 284 to proceed within the lesson, the end user 282 or 284 types “1” at the requested location. If desired, the course developer can select the font pane 922 to change the font of the text and background color that will be presented to the end user 282 or 284. A password character pane 942 can be a “yes” or “no” selection depending on whether the text that the end user 282 or 284 types is masked as commonly occurs in password entry. A show text pane 982 can be a “yes” or “no” selection depending on whether the text in pane 924 should be displayed to the end user 282 or 284.

FIG. 10 includes a view 100 of a text box object manager. The properties of a text box can be defined by using this feature or by using an electronic pointing device. The editing pane 1002 can be used to indicate whether a text box (panel) 1402 is displayed in edit mode, or whether it should be displayed as it should appear to an end user 282 or 284. Text cannot be changed when “no” is selected. X-position pane 1004 can be used to set the X-coordinate on the page for the text box, and the Y-position pane 1006 can be used to set the y-coordinate on the page for the text box. The course developer 202 can also move the text box 1402 by clicking on it and dragging it on the electronic pointing device 146.

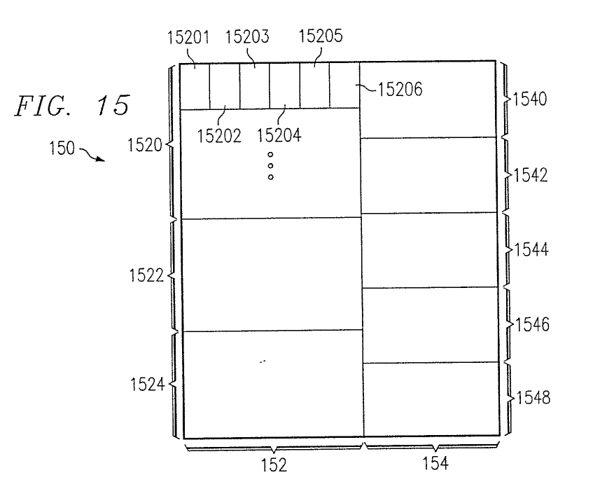

FIG. 11 includes a view 110 of a hotspot object manager. The properties of a hotspot relate mainly to where it is to be placed and what the arrow should appear. In autoposition pane 1102, the course developer 202 can select whether the direction of an arrow or hand is defined manually (“no”) or automatically (“yes”) by making the appropriate selection. When autopositioning is activated (“yes”), the orientation of the arrow or hand is automatically changed to keep it within the boundaries of the end-user lesson view 38. A pointer direction pane 1122 can be used to manually define the direction of the hand or arrow. The pointer direction pane 1122 is effective if the autopositioning pane 1102 is set to “no.” A show pointer pane 1124 can be used to define whether the arrow or hand is displayed or not in a particular sequence of a lesson. Generally, the show pointer pane 1124 should be set to “no” in sequences in which the end user 282 or 284 may type in text or key in a particular combination. Sizing and positioning of a hotspot object can be performed using a height pane 1142, a X-position pane 1144, a Y-position pane 1146, and a width pane 1148.

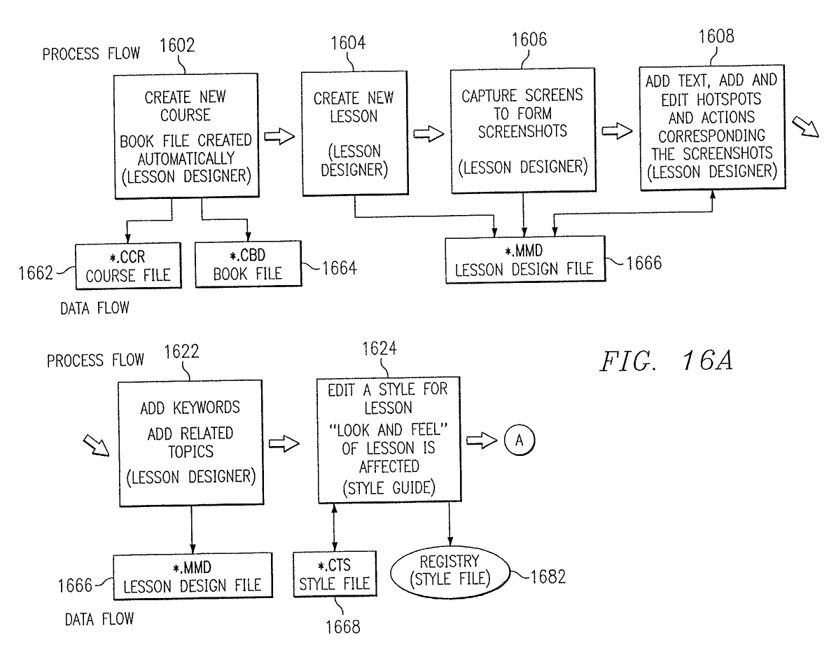

A soft guide frame object is similar to a hotspot object in a lesson and a test. The soft guide frame defines more precisely what the end user 282 or 284 may see in a soft guide. FIG. 12 includes a view 120 of the soft guide frame object manager. The functions and descriptions of panes 1202, 1222, 1224, 1244, and 1246 are similar to the corresponding panes 1102, 1122, 1124, 1144, and 1146 except that the panes in FIG. 12 affect a soft guide frame rather than a hotspot.

The development tool also includes a page manager. The largest area in a soft guide designer view displays the current page. The course developer 202 can insert other objects, such as text and hotspots, into this page, or screen. The development tool can also process these objects directly in page view or via the object manager. FIG. 13 includes a view 130 of a hand with a pointer 1302 pointing to a hotspot 1304 within a hotspot box 1306. In this particular embodiment, the hotspot is the close window icon of the target software program.

The hand with the pointer 1302 can be placed on a page by clicking the hotspot icon 466 and then dragging a hotspot onto the page. When a hotspot is first created, the course developer 202 can see a hand pointing to a center of a field in a lesson. If a soft guide topic is created, the course developer may see an arrow (not shown in FIG. 13) that replaces the hand with the pointer. The properties of the hand 1302 can be changed in various ways. Many of the properties may be changed using the electronic pointing device 146 or a combination of keys. Some of the combinations of keys include the following.

CTRL+arrow key: Moves a hotspot in small steps in the direction of the selected arrow.

CTRL+SHIFT+arrow key: Moves a hotspot in large steps in the direction of the selected arrow.

SHIFT+arrow key: Changes the size of a hotspot.

SHIFT+CTRL+ALT+arrow key: Changes the direction of a hand.

Alternatively, the hotspot can be moved by clicking it and dragging it to a desired location. The size of the hotspot can be changed by dragging its sides. The direction of the hand can be changed by holding the CTRL and SHIFT keys down simultaneously as the course developer 202 clicks and drags the round point 1304. A position of the hand within an action bar can be changed by holding down the CTRL key and dragging the round point.

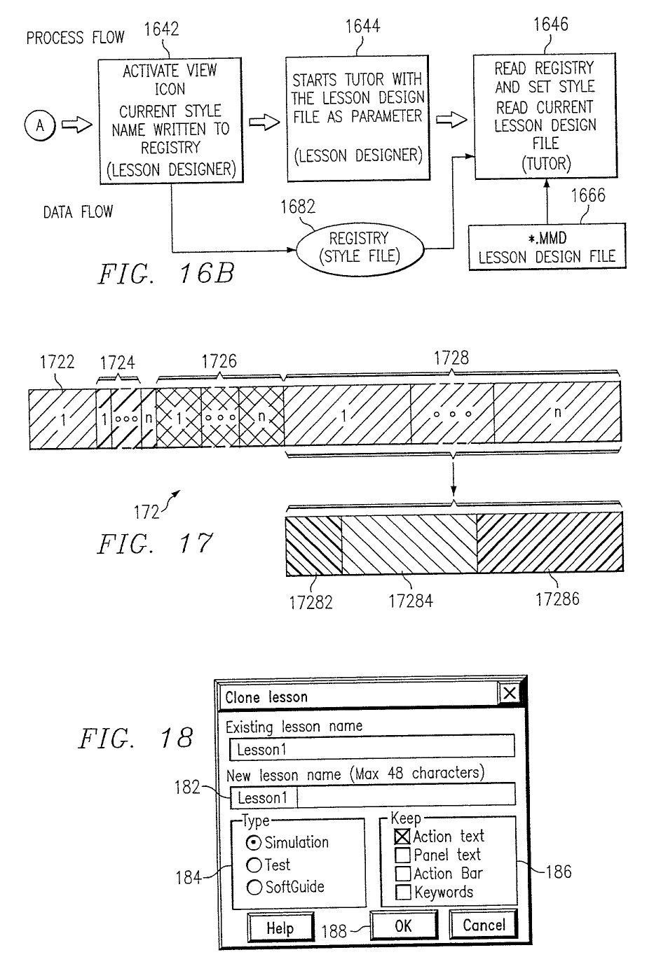

FIG. 14 includes a view 140 of the text panel object manager and includes a text panel 1402 and text 1404. The text panel object manager can be set to displayed or hidden using the view/object properties menu. Note that the setting may only apply during design. When the training guide is used by an end user 282 or 284, the text panel 1402 should be visible if it contains text, and it should not be shown if it does not contain text. The text panel 1402 can be moved by clicking on the upper part of the frame and dragging it. The text panel 1402 can be resized to match the amount of text that has been entered by using the CTRL-ENTER keys.

In alternate embodiments, the functionality provided by the various interfaces may be combined or placed into other interfaces. For example, the lesson and book developer interfaces may be placed into a single developer interface. Within the book developer interface, “icons” under the file category may be part of a style guide interface. The style guide interface may allow the course developer 202 to change the “look and feel” of the training guide. For the tutor 2622 or 2642, the style guide interface may be used to modify the front cover of the book, a navigation bar, or transitions between views (turning pages versus flipping pages). With the web guide 2624, soft guide 2646, or microguide 2644, the style guide interface may allow changing a color for a foreground object, a background object, a view window, icons, pointers, border of the text panel, and other graphical elements.

With hardware configurations and interfaces described, attention is now directed to using the development tool to create electronic training guides. The training guides can include a tutor 2622 or 2642, a web guide 2624 or soft guide 2644, a microguide 2646 or any combination thereof. Before starting, a high-level design of the tutor 2622 or 2642 should be made before starting to use the development tool. FIG. 15 includes a simplified block view of a possible design of the tutor 2622 or 2642, which includes course 150. In other embodiments, the tutor 2622 or 2642 could include more than one course. Course 150 includes modules 152 and 154. Modules 152 and 154 generally correspond to chapters of a book. The course may include more or fewer modules. Module 152 includes lessons 1520, 1522, and 1524, and module 154 includes lessons 1540, 1542, 1544, 1546, and 1548. A module may include nearly any finite number of lessons. Lesson 1520 includes lesson pages 15201-15206 and potentially other lesson pages. A lesson can include nearly any finite number of lesson pages. Each lesson page may include text, graphics, and links to other text or graphics. A good job of designing before starting may reduce the amount of subsequent editing and reduce the total time needed to create the training guides.

FIG. 16 includes flow diagrams for the process and data when creating a course. The development tool may be accessed or launched by reading the appropriate file(s) from the storage device 162 and loading the file(s) into RAM 164. The processor 122 executes instructions that are within code from the development tool. The target software program should be accessed or launched if this has not already been done.

At this point, the course developer 202 may use the functions within the development tool to create a new course (block 1602). In one embodiment, the course developer 202 uses the lesson designer interface to select a new course, names it, and saves it. For this example, the target software program for the book can be Microsoft Word 97™, and the course may be entitled “MS Word 97.” The course is then saved. Alternatively, if the course already existed, it would be opened. At this point in time, a course file 1662 and a book file 1664 can exist. A new lesson may be created (block 1604) with the creation of the course file or may be created by separately from the creation of the course file. The course developer 202 names the lesson design file 1666 and saves it.

The course developer 202 captures screens from the target software program using a screen capture module by sending a signal or signals to the data processing system 10. The screen capture module is part of the development tool and can be used to form screenshots (block 1606) that can be saved in the lesson design file 1666. The process is started by registering screens using the tools pull-down menu, pressing F6, or by activating the screen icon 502. At that time, screens may be captured by pressing CTRL+F11 to form the screenshots. Alternatively, the course developer 202 may use the settings item under the tools category within the lesson designer interface to define a different key or combination of keys to capture the screens. In one embodiment, the screenshots are formed using conventional screen capture software having a Windows™ application program interface (API). The screenshots should correspond to the graphical views that a user of the target software program would see when performing a task or operation. When the course developer 202 has captured the desired views for the lesson, the course developer 202 stops the registration by pressing SHIFT+“break.” Alternatively, the registration may be stopped by restoring the development tool and selecting stop registration from the tools pull down menu.

Returning to the example, the module or chapter may be entitled “Getting started” within the MS Word 97 tutorial being created, and the specific lesson corresponds to the task of printing. If a task may be performed in different manners (menu bar versus tool bar), both sets of screens may be captured. Part of the screenshots may include views of a dialog box with printing options (print certain page(s) or a selected portion) and the dialog box with the “Okay” and “Cancel” icons. Note that two different screenshots may be taken of the same graphical view so that each activity of a task can be specifically identified. Generally, it is better to err on the side of capturing too many screenshots.

During the screen capture mode, the screenshots can be in the native Windows™ bitmap format. Other formats may be used for other data processing system platforms. In Windows™ bitmap format, each screen shot can have a size in a range of approximately 500 Kb to 4 Mb. To reduce the storage size, at least some compression of the screenshots may save on storage space. Many graphics formats, such as JPEG, GIF, TIFF, PNG, and the like, perform compression.

To preserve image quality, graphics files can be compressed using a conventional lossless compression technique, in which substantially no is lost. Compression may performed using a ZLIB, Six Pack, or other similar widely available technique. The PKZIP compression technology, originally developed by PKWARE, Inc. is an example of lossless compression. In one specific embodiment public domain library ZLIB, which is PKZIP compatible can be used. Alternatively, Six Pack, by Philip G. Gage, can be obtained over the Internet from a number of sources.

For a conventional compression technique, when many pixels from the bitmap that originated from a graphical image are repeated, the encoding algorithm using run length encoding converts that information into data that includes three segments. The first segment is called the indicator or sentinel. The first segment serves a couple of functions, it notes that a byte (specified in the third segment) appears for a specified number of pixels (specified in the second segment) and declares the data type (byte, word, or double word) for the number in the second segment. The second segment specifies how many times the byte in the third segment is to be repeated, and the third segment has the byte that is repeated. The first and third segments typically are each one byte long, and the second segment is one byte, one word, or one double word long. Therefore, the data using conventional run length encoding will be at least three bytes long. The time needed to process a file depends on the resolution of the image and the content of the image itself.

A compression module including a “packer” and a conventional compression can be used to reduce the size of the graphical files. Unlike conventional compression techniques, the information will be packed (processed) using a modified compression algorithm before using a conventional compression algorithm to form a compressed file. Skilled artisans appreciate that a pixel within an image can be represented by a byte (8-bits) or any other number of bits, depending on the number of possible colors in the bitmap. A word (16-bits) or double word (32-bits) may be used if the number of colons is increased.

Unlike the prior algorithms, a “nibble” or “half byte” (no more than 16 repeated bytes), byte, word, or double word indicator or sentinel can be used for the first segment. If the first segment identifies a nibble or half byte, the second segment in the conventional algorithms can be omitted. Therefore, a repeating data structure with more than three repeating pixels can be represented by no more than two bytes. Therefore, one byte of memory space may be saved compared to the conventional algorithm. The output of the packing will be referred to as an intermediate output structure. The algorithm is better understood with the following explanation of values and examples.

Value $00 . . . $0D can be used to represent the original byte. The algorithm instructs the processor 122 to copy the original byte to the intermediate output structure and move one byte forward.

Value $0E can be used for instances when the original data structure contains bytes in an indicator range (e.g., the byte actually is $11). It signifies that the next byte is an original byte. It is similar to an escape sequence seen in C++ and other computer programming languages.

Value $10 can be used to indicate that the second segment has a numeric value of 255 or less (a byte). The value $10 is typically used when an original byte is repeated 17-255 times.

Value $11 can be used to indicate that the second segment has a numeric value of 65535 or less (a word). The value $11 is typically used when an original byte is repeated 256-65535 times.

Value $13 . . . $1F can be used to indicate that an original byte is repeated 3-16 times. This is the nibble or half byte indicator.

Value $20 . . . $FF can be used to represent the original byte. The original byte is copied to the intermediate output structure, and the algorithm instructs the processor 122 to move one byte forward.

The following examples illustrate how the packing algorithm can be used to form an intermediate output structure. Original bytes that appear by one or two consecutive times are just written and not compressed.

### EXAMPLE 1

Original data structure can be ABBCDEEEFGH, which is 11 bytes long. The description below describes the instructions that are followed by the processor 122 to form an intermediate output structure (“packed” structure) when using the packing algorithm.

1. Write A

The processor 122 detects two “B” bytes in a row, but the two “B” bytes are not represented in a different manner because there is no savings.

2. Write B

3. Write B

4. Write C

5. Write D

The processor 122 detects three “E” bytes in a row. The nibble or byte indicator is used. One byte is saved.

6a. Write $13 (indicator to represent three bytes in a row of the next byte written)

6b. Write E (the original byte that is repeated three times)

7. Write F

8. Write G

9. Write H

### EXAMPLE 2

Original data structure can be ABBCDEEEEEEEEEEEEEEEEEEEEEEEEEEEEEEFGH, which is 37 bytes long. The “E” byte is repeated 30 times. The description below describes the instructions that are followed by the processor 122 to form an intermediate output structure (“packed” structure) when using the packing algorithm. The intermediate output structure can have 27 fewer bytes compared to the original structure.

1. Write A

2. Write B

3. Write B

4. Write C

5. Write D

The processor 122 detects 30 “E” bytes in a row. The byte indicator is used.

6a. Write $10 (indicator to represent that that next data (in 6b) includes a decimal representation that does not exceed one byte)

6b. Write $1E (converts to a decimal value of 30)

6c. Write E (the original byte that is repeated three times)

7. Write F

8. Write G

9. Write H

### EXAMPLE 3

Original data structure can be ABBCD . . . (14,500 “E” bytes) . . . FGH, which is 14,508 bytes long. The “E” byte is repeated 14,500 times. The description below describes the instructions that are followed by the processor 122 to form an intermediate output structure (“packed” structure) when using the packing algorithm. The intermediate output structure can have 14,496 fewer bytes compared to the original structure.

1. Write A

2. Write B

3. Write B

4. Write C

5. Write D

The processor 122 detects 14,500 “E” bytes in a row. The byte indicator is used.

6a. Write $11 (indicator to represent that that next data (in 6b) includes a decimal representation that does not exceed one word)

6b. Write $38A4 (converts to a decimal value of 14,500)

6c. Write E (the original byte that is repeated 14,500 times)

7. Write F

8. Write G

9. Write H

After packing, the intermediate output structure is compressed using a conventional lossless compression technique previously described. If resolution is not important, a conventional lossy compression technique could be used. The packing allows a more efficient data representation compared to the original representation. The compression can be performed quicker and result in a smaller file. Unexpectedly, the cumulative time for packing and conventional compressing can be substantially shorter than conventional compressing by itself. A test can be performed using a Windows™ bitmap 8-bit color image that has an original size of about 1.3 MB.

In one embodiment, compression can be performed using relatively low-level compression (high speed) with either algorithm. A ZLIB library is supported by the most common web browsers, and is part of Borland Delphi™ software available from Borland Software Corporation of Scotts Valley, Calif. The algorithms can be used to perform relatively low-level compression during course development to allow less delay to the course developer 202 when developing the course.

When a conventional ZLIB compression algorithm is used without packing, the final output data structure is approximately 91 kB in size and takes about 3,000 milliseconds to perform. When the packing algorithm and conventional ZLIB compression algorithm are used, the final output data structure is approximately 85 kB in size and takes about 330 milliseconds to perform. The file is about six percent smaller. Unexpectedly, the time to pack and compress is almost ten times faster than the time to compress using the conventional ZLIB algorithm compressing by itself (on the original data structure).

When a conventional Six Pack compression algorithm is used without packing, the final output data structure is approximately 116 kB in size and takes about 3,400 milliseconds to perform. When the packing algorithm and conventional Six Pack compression algorithm are used, the final output data structure is approximately 87 kB in size and takes about 590 milliseconds to perform. The file is about 25 percent smaller. Unexpectedly, the time to pack and compress is more than five times faster than the time to compress using conventional Six Pack algorithm compressing by itself (on the original data structure).

The time and space savings may depend on the image, its size, and color level (e.g., 16-bit color, 32-bit color, etc.). The improvements described are expected to become more noticeable as the color level (e.g., 16-bit color, 32-bit color) increases. The course developer 202 should experience at least a three times improvement on speed and a smaller final output structure when comparing packing and conventional compression to conventional compression by itself. The compressed file can be compiled into the executable without a need for a dynamically linked library. If the data structures would be files, the size of the original file would be larger than an intermediate output file, which would be larger than the final output file.

In other embodiments, additional or different indicators can be used for the packing. For example, an indicator may be added for a double word, a quad word, or the like. The values used for the indicators can be changed, but generally should be values that appear less frequently in the data to be compressed. In an alternative embodiment, packing may be used as a replacement to conventional compression. Therefore, the compression module may include the “packer” technique, any conventional compression technique, or any combination thereof.

The development tool can include a editor module that allows for adding or editing text, hotspots, end user 282 or 284 actions, keywords, related topics, or the like. The course developer 202 can communicate with the data processing system 10 by sending and receiving appropriate signals for the functions described in more detail below. Returning to creating a training guide in FIG. 16, text corresponding to each screenshot is added using the development tool (block 1608) and can be saved in the lesson design file 1666 as seen in FIG. 16. The text may be added as a text panel by using the panel item with in the view pull-down menu or use show panel icon 462 (of FIG. 4) of the lesson design interface. Text is typically added by sending signals from the course developer 202 to the data processing system 10. The course developer may add text to the book corresponding to each screen shot by using the book designer item within the tools pull-down menu. The book designer interface as seen in FIG. 6 can become visible to the course developer 202. Alternatively, the course developer 202 may add text corresponding to each screenshot in the lesson, and potentially perform other acts, before moving to the book designer interface. When using the book designer interface, the course developer 202 may add text to the book that corresponds to the screenshots within the lesson. The course developer 202 can return to the lesson design interface by activating icon 68 shown in FIG. 6.

Hotspots may be added to by using hotspot icon 466. The course developer 202 activates the icon 466, which changes the pointer to a cross within the captured screenshot. The hotspots may be edited by the course developer 202 as he or she desires (block 1608). The course developer can place one diagonal comer of a feature within the screenshot that he or she desires to highlight. The course developer 202 presses the left-click pad on electronic pointing device 146, and while holding the pad down, drag the cross to the opposite diagonal comer of the area to be highlighted. When the course developer 202 releases the pad, the area can be marked by a green line and a red dot within the center of the area.

The course developer 202 may adjust the position of the hotspot box by left-clicking near the center of the area and moving it around and may adjust the size of the area by left-clicking on the green lines and dragging the side(s) to the appropriate size(s). Alternatively, the positioning and size can be adjusted by selecting the hotspot properties item from the pull-down menu under the tool bar near the left-hand side of the lesson designer interface. The course developer 202 can determine whether a graphic pointer will be shown and in what direction the graphical pointer will point.

The course developer 202 can use the main page object manager from the same pull-down menu as the hot spot item to set other properties. The main page object manager includes a user interaction editor module, which is part of the editor module. The course developer 202 may determine the action needed for proceeding through the lesson. This can include an action from a feature of electronic pointing device 146, an action key from keyboard 144, a system key from keyboard 144, or a combination of an action key and a system key from keyboard 144. The course developer 202 can select a background color, text font, and text to be entered. The user interaction editor module may include more or fewer features than described in this paragraph.

After the pages within a lesson have been defined, the course developer 202 can add keywords and related topics (block 1622) that can be saved in the lesson design file 1666. Keywords can be added by activating icon 467 or using the keywords item within the view category of the pull-down menu for the lesson designer interface. Related topics can be added by activating icon 470 or using the related topics item within the view category of the pull-down menu for the lesson designer interface.

In alternative embodiments, the text may be added after the hotspots are defined or after properties from the main page (mostly actions required to proceed in a lesson) are performed. Keywords or related topics can be added at nearly any time during the creation of the lesson. Any of these text-containing objects may be added after working on a different lesson and then coming back to this lesson. All the information that the course developer 202 wants to be in the lesson should be present prior to previewing a lesson.

The course developer 202 may use a style edition module to edit a style file 1668 for the lesson (block 1624) via the style guide interface to create part of a registry 1682 within the style file 1668 as shown in FIG. 16. The style can affect the appearance the of the book and guides. The style guide interface may allow the course developer 202 to change the “look and feel” of the training guide (and also the book). For the web guide 2624, soft guide 2646, or microguide 2644, the style guide interface may allow changing a color for a foreground object, a background object, or a view window, or the like.

The course developer 202 may view the lesson the way it would appear to the end user 282 or 284 by activating the view icon 508 (block 1642 in FIG. 16-B) or by activating the preview lesson item within the course category of the pull-down menu within the lesson designer interface. The development tool structures the lesson design file 1666 into an array 172 as shown in FIG. 17. The lesson file format includes an array of information as illustrated in FIG. 17. The lesson design file 1666 includes a header portion 1722, an offsets portion 1724, a records portion 1726, and a binary large objects (blobs) portion 1728. The header portion 1722 includes information regarding the version, type, and name of the lesson, the chapter or module name, course name, the number of records, and the like.

The offsets portion 1724 includes information for each of the pages 1 to n. More specifically, for each page of the lesson, the offsets portion 1724 includes information to locate the corresponding information within the records portion 1726 and blobs portion 1728 for that specific page. The records portion 1726 includes one set of records for each page of the lesson. The information includes data regarding hotspot coordinates described in view 110, graphical pointer position and direction described in view 110, type of action listed in action pane 902, action key value in action key pane 904, system key value in system key pane 906, test initial text in pane 924, test reply text in pane 962, edit box back color (the background color for the hotspot rectangle 1306 and is only used if reply text is present in pane 962), or the like. Each of the segments within the blobs portion 1728 corresponds to a page of the lesson. For each page, the blobs portion 1728 includes information regarding action text 17282 (from panes 924 and 962 in FIG. 9), text box (panel) 17284 (text 1402 in FIG. 14), and a compressed version of the corresponding screenshot 17286.

This array format can allow fast reading and writing of data to maintain interactivity with the course developer 202 without any significant delays as seen from the perspective of the course developer 202. The course developer 202 should not have to wait long when performing the preview or performing further editing of the lesson.

During the preview, the development tool writes a style name as chosen by the course developer 202 to the registry 1682. If a style name has not been chosen, the development tool will use a default style. The development tool includes instructions for the processor 122 to start the tutor 2642 with the lesson design file as a parameter (block 1644 in FIG. 16-B). The processor 122 reads the registry and sets the style accordingly (block 1646). The current lesson is then automatically opened within the tutor 2642. When done, a book-shaped icon near the upper right hand portion flashes when the course developer 202 has completed previewing the lesson. The icon returns the course developer 202 to the lesson designer interface.

At this point, a lesson has been created and previewed. In this embodiment, each page of the lesson corresponds to a screenshot that was formed during the capture act. The pages (including screenshots) in the lesson appear in the order in which the end user 282 or 284 would see them when performing a task (e.g., printing a document) within the target software application (e.g., Microsoft Word 9{fourth root}). Additional lessons can be added by the course developer 202 until the course has all the lessons that it needs. Note that a course could include as few as one lesson. For an additional lesson, the course developer 202 may activate the new lesson icon 422 or use the new lesson item under the file category within the lesson designer interface. The procedure described above can be followed to create the new or additional lessons.

The course developer 202 can assemble the information into training guides that can be used by end user 282 or 284. As used herein, “assemble” is defined broadly to include bringing together various parts and to create a group or whole, and not limited to assembling programming code. The training guides can be any of the tutors 2622 or 2642 or the guides 2624, 2644, or 2646. Part of assembling can be performed by an assembly module of the development tool. The course developer 202 can send signals to the data processing system to cause the development to carry out its portions of the assembly operation. An output of the assembly module can include a runtime file, an executable file, or the like.

Attention is now directed to creating the tests for the tutor and guides. The course developer 202 can make the tests and guides by cloning the lesson. The course developer 202 selects the clone item from the file category of the pull-down menu within the lesson designer interface. The course designer will see view 180 as shown in FIG. 18. The course developer 202 types in the name of the test or guide in text box 182. The course developer 202 chooses the type of clone within box 184. In one specific example, “Test” is chosen. The course developer 202 determines what to keep from the original lesson from which the test or guide is being copied. In the box 186, the course developer 202 is selecting to keep the “Action text” (pane 924 in FIG. 9), but not the “Panel text” (view 140 in FIG. 14), the “Action bar” (box 36 in FIG. 3), or the “Keywords” (icon 467 of FIG. 4). If the course developer 202 is satisfied with his or her choice, the “OK” icon 188 is activated.

Guides are formed in a similar manner. The “SoftGuide” selection would be chosen in box 164. The guide is initially created as a soft guide 2646, but it can be used as a web guide 2624 or converted to a microguide 2644 as will be described later. If a lesson is to be duplicated for a similar, but different lesson, “Simulation” can be chosen in box 164. Nearly any combination of types (box 164) and one or more of the “Keep” items within box 166 can be selected.

From the perspective of the system 10, the following actions are used in creating the web guide 2624 or soft guide 2646 and are illustrated in FIG. 19. When the course developer 202 activates the soft guide icon 510 (in FIG. 5), the development tool (within storage device 162 or RAM 164) sends instructions to the processor 122 to read the style file 1668 and lesson design file 1666 (block 1902). The processor 122 compiles the lesson design file 1666 into the soft guide lesson 1962 (also called runtime version of the soft guide lesson file) for the lesson (block 1904). The course developer 202 is displayed the soft guide runtime file 1962 as the end user 282 or 284 should see it. The course developer 202 can advance through (play back) the soft guide file 1962 (block 1906). When he or she is done, the course developer 202 returns to the lesson designer interface.

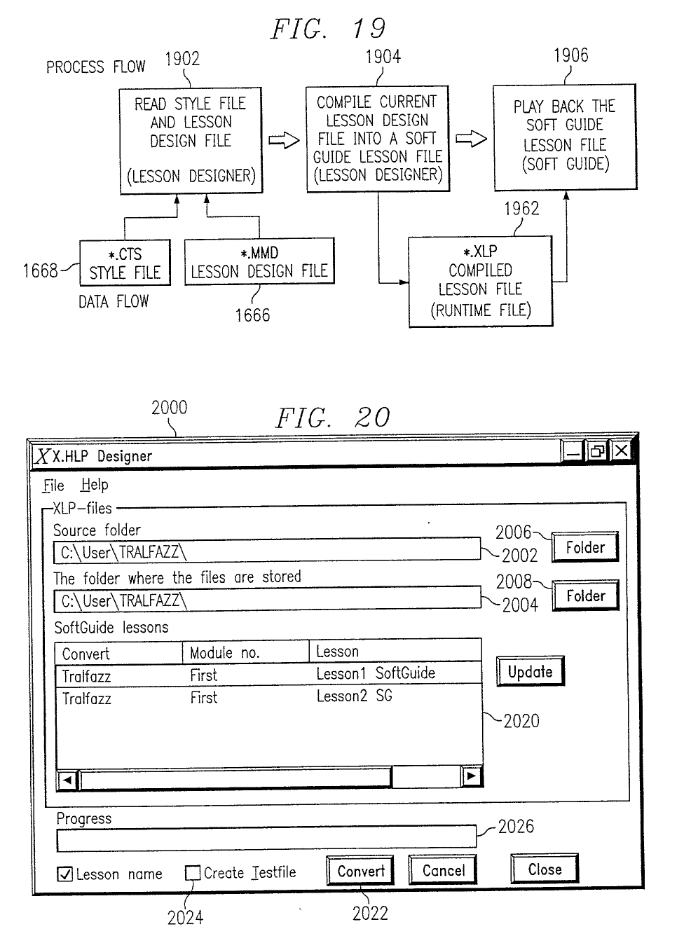

The guide described above can be used as the web guide 2624 or the soft guide 2646. The soft guide 2646 can be converted to a microguide 2644 by selecting the microguide item under the file category within the lesson designer interface. The course developer 202 should see the view 2000 in FIG. 20. The source and destination folders are shown in lines 2002 and 2004, respectively. If either needs to be changed, the course developer activates the proper folder panel 2006 or 2008, as appropriate. If the source and destination folders are proper, the course developer highlights the soft guide files in region 2020 from which the microguide files are formed and activates the convert button 2022. If the course developer 202 wants to create a test file, the “Create testfile” box 2024 can be marked. The progress of the conversion is displayed to the course developer 202 in box 2026. At the end, the course developer 202 will have the original soft guide file and a new microguide file. When the course developer 202 is finished, he or she closes the view. Update button 2010 refreshes the list of soft guides shown in region 2020.

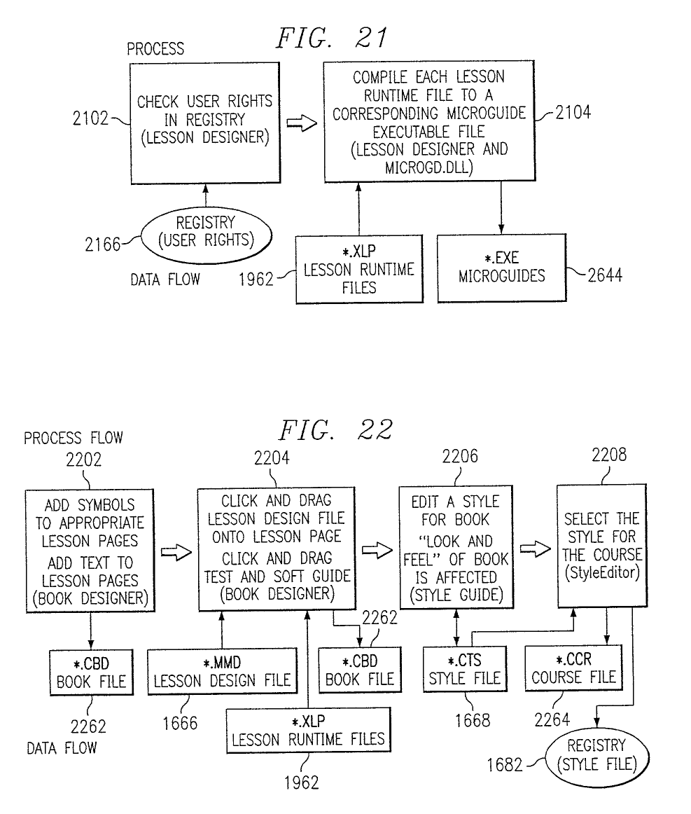

From the perspective of the system 10, a registry 2162 is checked for user rights as shown in block 2102 in FIG. 21. If the registry notes that microguide rights are available, the process proceeds. The development tool provides instructions to the processor 122 to compile the lesson runtime file 1962 into microguide 2644 using the microguide dynamically linked library (“MICROGD.DLL”) as shown in block 2104 in FIG. 21. During compilation, some or all of the lesson runtime file is used to form a microguide data portion.

The processor 122 using a microguide generation module within the development tool opens the microguide dynamically linked library (dll) where the microguide executable program code is stored. The microguide executable program code is read from the dll and written to a file created within storage device 162. The microguide data portion is then appended to the microguide executable code in the disk file. Then several extra integers are appended to the file that indicate where the microguide data portion starts in the file and how big the microguide data portion is (microguide position data). Finally, the file is saved and closed.

When a microguide begins execution, the processor 122 opens the microguide executable file 2644 as a data file. The processor 122 goes to the end of the file and reads the numbers from the end of the file that tell it where the microguide data portion starts and the size of the portion. The microguide executable file positions its read pointer to the place in the file where the microguide data portion begins and reads the microguide data portion. Subsequently, the microguide executable file executes in substantially the same manner as the soft guide 2646.

The content of the web guide 2624 (which includes file 1962), soft guide 2646 (which includes file 1962), and microguide 2644 (created using file 1962) are substantially the same. Web guide 2624 is accessible via the Internet, the soft guide 2646 typically resides on a storage device 162 of an end user 282 or 284 or a server, and the microguide 2644 can be a stand-alone executable (.exe) file.

The course developer 202 may use the book designer interface to edit the book file 2262 (also called the book design file), type text into the book, include hyperlinks, and create links to other parts of the tutor including the lesson design files, tests, soft guides, related topics, keywords, or any combination thereof. Before starting, the course developer 202 identifies the text symbol or other desired symbol(s) from the book design interface tool bar that he or she wants to use in the book. The course developer 202 can add the text symbol or other desired symbol(s) by clicking and dragging it (or them) from the tool bar 64 and place on the lesson pages of the tutor in which they belong as seen in block 2202 in FIG. 22. The course developer 202 clicks and drags the appropriate lesson design file from the file object manager onto an unused part of the lesson pages for that lesson (block 2204). This links the “show me” and related topics symbols on the page to the lesson. Additionally, this links the keywords and related topics of the lesson to the lesson pages. If desired, the course developer can add a soft guide file or a test file to the appropriate symbol by clicking on the soft guide file or test file from the file object manager and dragging the file (or files) onto the appropriate symbol (or symbols) on the lesson pages within the book (block 2204). The information related to the text and various links to other files is saved within the book file 2262.

The course developer 202 may edit the style of the book by using the style guide interface (block 2206). The style guide interface may allow the course developer 202 to change the “look and feel” of the book. For the tutor 2622 or 2642, the style guide interface may be used to modify the front cover of the book, a navigation bar, transition between views (turning pages versus flipping pages), or the like. If desired, the course developer 202 can also edit the style of the lessons and soft guides, too. The course developer 202 selects the style for the course and saves the style in the course file 2264 and the registry 1682 (block 2208).

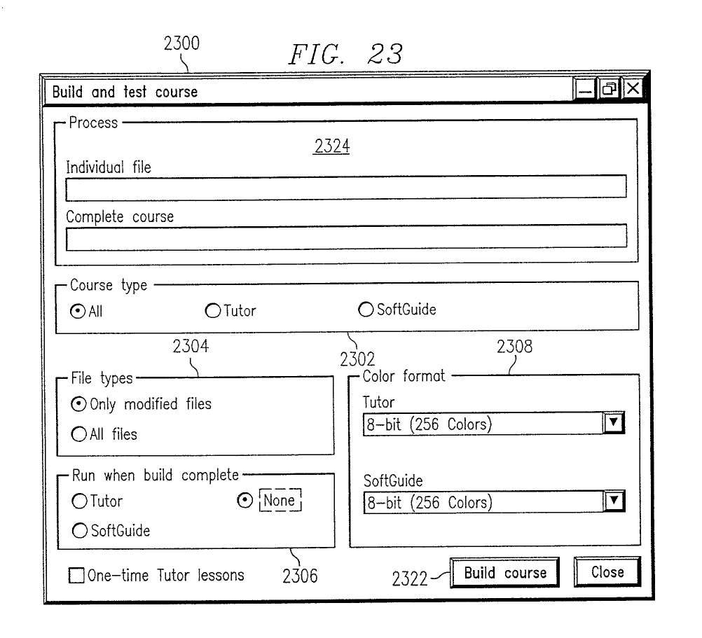

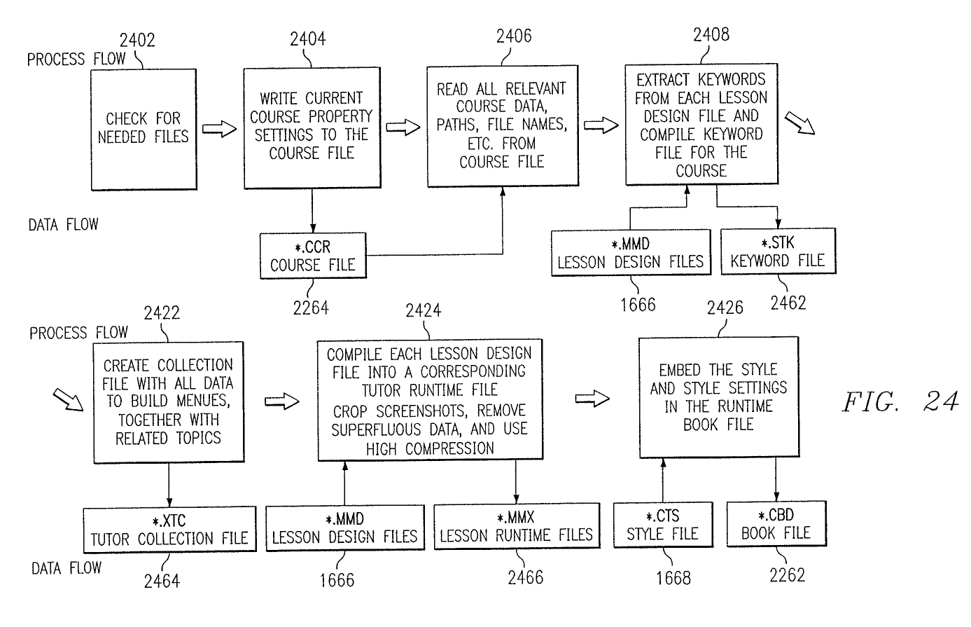

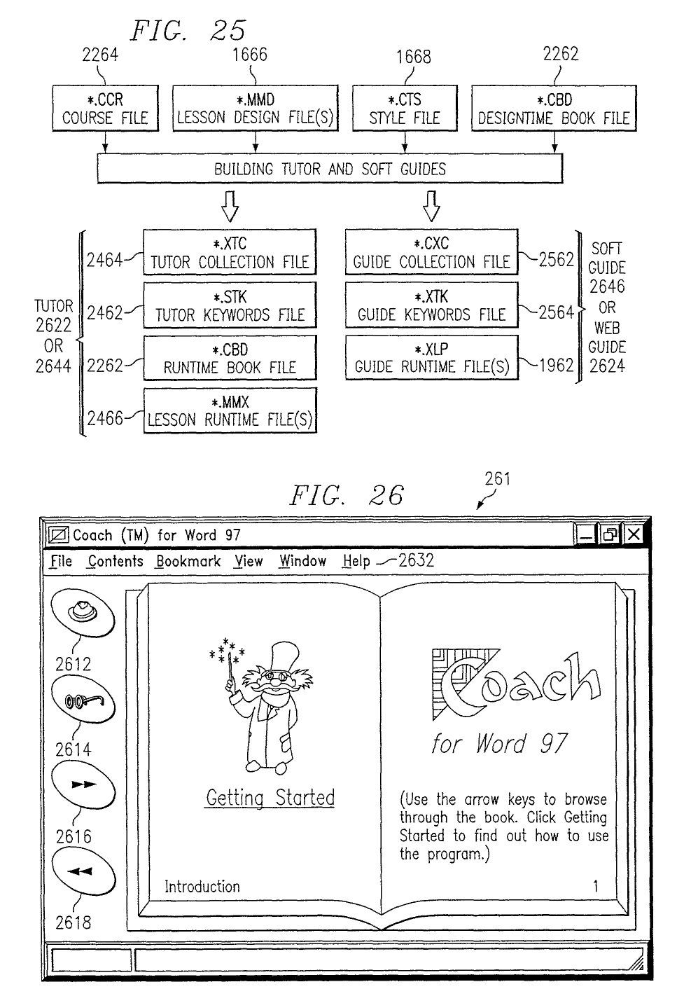

The runtime book file 2262 is now ready to be built. The runtime book file can be a compressed version of the design time book file with a style embedded within the file. The course designer 202 returns to the lesson design interface and can activate the build icon 512. The course developer 202 will see view 2300 in FIG. 23. The course designer 202 selects whether the course has a type of all, tutor, or soft guide within the course type box 2302. The course developer 202 can select whether only modified files or all files will be rebuilt by making the appropriate selection within the files type box 2304. The course developer 202 may determine whether the tutor, soft guide or neither will be run (previewed) when building is completed by making the appropriate selection within box 2306. Color format box 2308 can be used to select the appropriate color level for the tutor and soft guide by using the appropriate pull-down menu. The course developer 202 activates the “Build course” button 2322 when he or she is ready.

The process box 2324 in FIG. 23 shows the progress while the individual files are being processed and the course is being built. When done, the course developer 202 can go to the end user tutor view, the end user soft guide view, or return to the lesson designer interface depending on the selection made in box 2306.

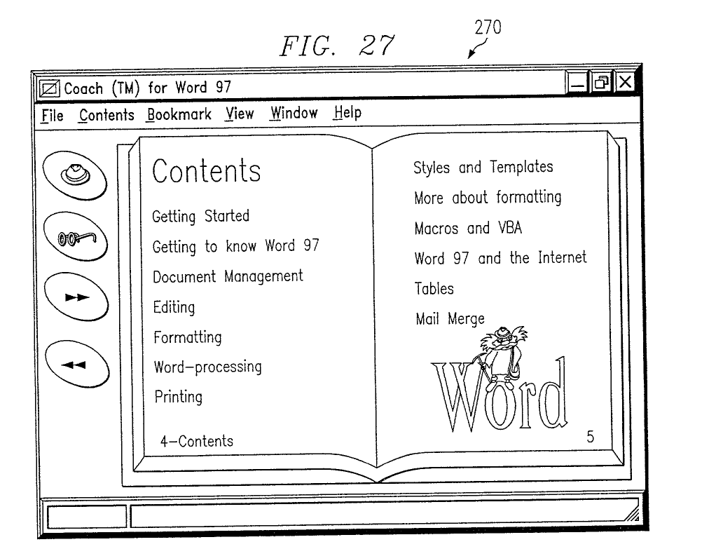

From a perspective of the system 10, the following actions occur as illustrated in FIG. 24. The system 10 checks to ensure that files needed are present (block 2402), and the processor 122 writes current course property settings to the course file 2264 (block 2404). All relevant course data, paths, file names, and the like are read from the course file 2264 (block 2406). Keywords are extracted from the lesson design files 1666 and compiled into a keyword file 2462 for the course (block 2408). A tutor collection file 2464 is created and includes data to build menus, together with related topics information (block 2422). Each lesson design file 1666 is compiled into a corresponding lesson runtime file 2466 (block 2424). The compiling can include cropping screenshots, adjusting hotspots, removing superfluous data, and using high compression. Style and style settings are embedded in the runtime book file 2262 (block 2426). Note that the fmished runtime book file 2262 is part of the tutor 2622 or 2642 as first introduced in FIG. 2.

The development tool may be designed to perform an autodelete function for empty pages. For example, when the course developer 202 created a book, a page may have been inserted. Later, the course developer 202 may not have needed the page. When the files are saved or the tutor 2622 or 2642 is built, the development tool 202 may include instructions for the processor to automatically delete lesson pages within the tutor 2622 or 2642 that do not have any text, graphical images, or other information within the body of the page. That empty page may or may not have a header or footer on that page. The lack of information within the body activates the delete fimction (corresponding to the course developer using the delete page function described above). The development tool may renumber the subsequent pages (with respect to the deleted page) after the deletion. This function helps to eliminate an inadvertent blank page that could result in numerous end user 282 or 284 questions regarding the blank page.

FIG. 25 includes an illustration of the different types of files and where they may be principally used. Files above the building block 2502 are typically created by the course developer 202 before building. Files below the building block 2502 are created when the build icon 512 is activated. The files associated with the tutors and guides are illustrated. FIG. 25 only includes some of the files and is not meant to illustrate an exhaustive list.

The course file 2264 can include data from previous build(s), if any, the name of the style file, and paths used. The lesson design file 1666 can include a simulation, text, or soft guide design file. The lesson design file 1666 typically includes keywords and related topics for the particular lesson. Low compression is generally used with the lesson design file(s) 1666, and a course typically has one or more lesson design file. The style file 1668 can include information regarding the general look and feel of the course. The information can include book cover design, icons, pointers, transitions between views, and the like. A course typically has one style file. The design time book file 2262 can include text, graphics, icons, hyperlinks, and the like for the book. Each course has one book file.

The course developer 202 can review the data in the files used to build the course and create files for the tutor 2622 or 2642, the guide 2624 or 2646 (block 2502), or any combination thereof. The tutor collection file 2464 can have a list of lesson(s) in the course and related topics for the course. The tutor collection file 2464 can allow a fast building of menus. The course typically has one tutor collection file 2464. The keyword file 2462 can have keywords from the corresponding lesson design file(s) 1666 for the course. The runtime book file 2262 includes test, graphics, icons, hyperlinks, and the like within a book. The runtime book file 2262 also can include a style to be embedded within the book. Lesson runtime file(s) 2466 can include simulations or tests. Keywords and related topics are typically not included within these files. Each course typically has one or more lesson runtime file 2466 that is (are) highly compressed.

The guides 2624 or 2646 includes a soft guide collection file 2562. The file 2652 lists the guide(s) within the course to allow for a fast build of menus. The guide collection file 2562 can include related topics for the course. The course typically has one guide collection file. The guide keyword file 2564 for the course has the names of the corresponding guide runtime file(s) 1962. The course typically has one guide keyword file. The guide runtime files 1962 can include a cropped versions of the original screenshot(s) to keep the graphics to a reasonable size. The course typically has several guide runtime files. The guide runtime files can be compiled into the microguides 2644, which are stand-alone executable files.

The development tool may allow the course developer 202 to manually save the lesson design files and book design files. In an alternate embodiment, the development tool may be configured to automatically save the files. The automatic saving may occur when exiting the development tool or any time the course developer 202 inserts any information within a lesson or book and then moves to a different view within the development tool. Alternatively, the file or files may be saved on a timed basis.

After the training guide (or guides) have been built and approved, if desired, it (or they) can be distributed. The send icon 512 can be activated, and the course administrator 204, course developer 202, or the application expert 206 prepares the course for distribution. The options regarding distribution have been discussed earlier with reference to FIG. 1.

Attention is now directed to using the training guides. From end user's 282 or 284 perspective, the use of web tutor 2622 and soft tutor 2642 are similar. In using the electronic training guides, the end user 282 or 284 may communicate with the data processing system using signals, similar to the course developer using the data processing system with the development tool. For the purposes of explanation, the soft tutor 2642 and soft guide 2646 will be described as used by end user 284 with respect to a specific embodiment. Some differences between the web versions and “soft” versions are described later in this specification. The target software program for the tutor 2642 is Microsoft Word 97™ in this specific example. The end user 284 may be interested in learning about printing a document. Note that the content and styles may vary from course to course, but the structure should be similar.

When the tutor 2642 is started, a view 261 in FIG. 26 is presented to end user 284. At first, the cover (not shown) is displayed and turns to a page entitled “Getting Started.” End user 284 may use the icons within a navigation bar along the left-hand side of the book. The compass icon 2612 can be used to get the end user 284 to the table of contents. The glasses icon 2614 can be used to search for topics and includes an index of topics. The right-hand arrow icon 2616 and left-hand arrow icon 2618 can be used to allow the end user 284 to progress through the book one page at a time. The right-hand arrow icon 2616 can be used to turn to the next page, and the left-hand arrow icon 2618 can be used to turn to the previous page. Functions available to the end user 284 can be accessed using the various categories within the pull-down menus in section 2632. The categories include file, contents, bookmark, view, window, and help.

The file category includes the following functions.

Start program: used to start the targeted software program that is the subject of the tutor.

Print: used to print reports.

Exit: closes the tutor.

The contents category includes a list of the course(s) within the tutor. Although the course is for Microsoft Word 97™, the tutor could have been written for Microsoft Office 97™, and in this case, the courses may be directed to any of Microsoft Excel 97™, Microsoft PowerPoint 97™, and Microsoft Outlook 97™ in addition to or replacing Microsoft Word 97™. The bookmark category can be used to set a bookmark within the tutor 2642.

The view category includes the following functions.

Next: moves to the next page in the book.

Previous: moves to the previous page in the book.

Repeat: allows a test to be repeated.

Back: moves to the previous page where the end user 284 was prior to the current page.

Contents: moves to the table of contents page.

Index: brings up the index screen.

Text box: hides or displays the text box (panel) for each page of a lesson.

The window category includes the following functions.

Hide: minimizes the view (similar to minimize icon for Windows™-based software applications.

Stay on top: keeps the view at the highest level.

The help category includes the following functions.

Getting started: moves to the getting started page.

Guide: provides a quick graphical view and explanation regarding how to use the tutor 2646.

About: contains information regarding tutor 2646.

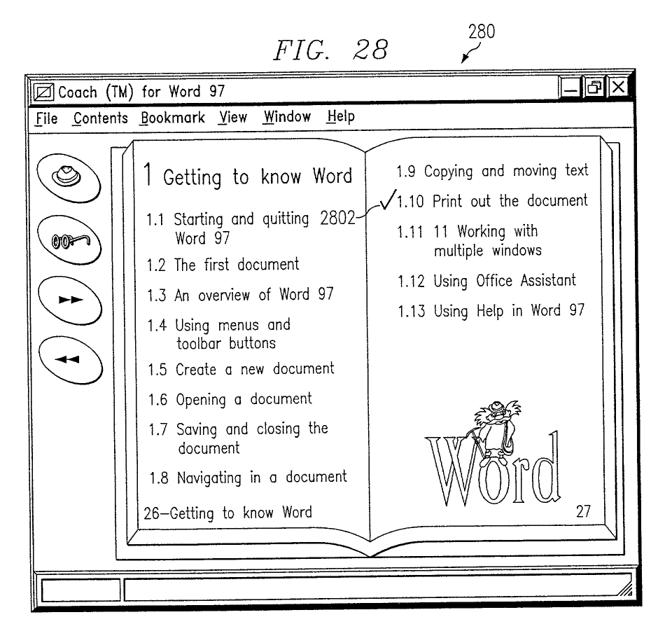

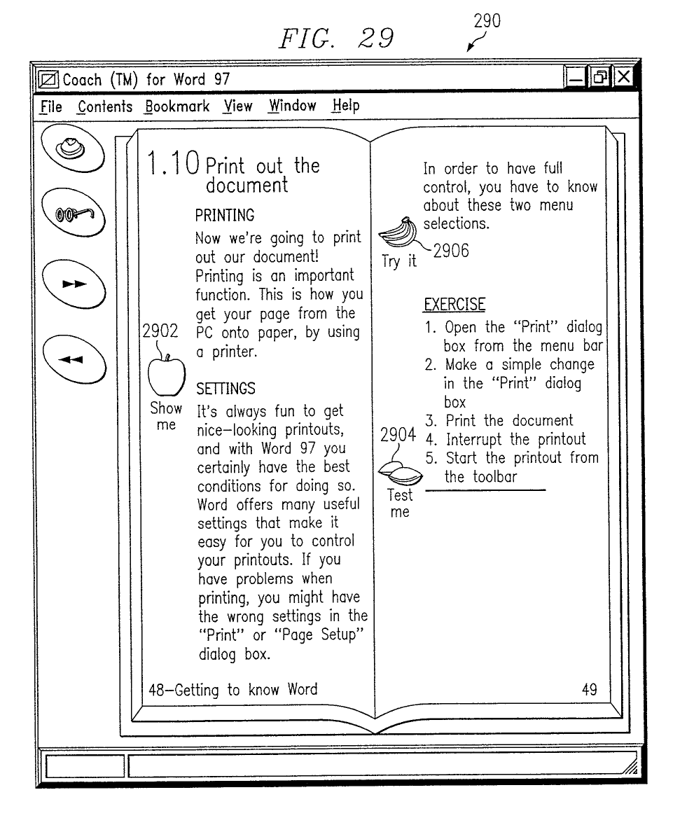

When end user 284 activates the compass icon 2612, the tutor moves to the table of contents as seen in view 270 of FIG. 27. The page is entitled “Contents” and each line within the pages seen in the view corresponds to a chapter or module of the course. “Getting to know Word 97” can be activated by using the electronic pointing device 146. The processor 122 proceeds to the chapter or module that corresponds to “Getting to know Word 97.” View 280 of FIG. 28 includes a list of sections within the module. Section 1.10 corresponds to a lesson regarding printing a document within Word 97. Initially, no check marks appear on the page. After a lesson is completed, a check mark 2802 is illustrated next to the section in which the check mark appears. End user 284 may find this very convenient for keeping track of which lessons have been taken and which have not. End user 284 may use the electronic pointing device 146 to turn to Section 1.10.

FIG. 29 includes a view 290 of the lesson for printing a Word 97 document. Soft tutor 2642 includes text describing the function and an exercise that may be performed for a test. The apple or “show me” symbol 2902 can be activated to move to view 300 of FIG. 30, which is the first page of a graphical lesson. The graphics-based lesson allows end user 284 to learn the function using interaction with the tutor 2646 in hopes that the end user 284 will be more likely to retain the concept being taught. To proceed through the lesson, the end user 284 follows the directions within the text box 302. The end user 284 can use the electronic pointing device 146 and click on the end of the graphical pointer 304 within the lesson to go to the next page of the lesson. The text from the text box 36 in FIG. 3 appears along a bottom portion 306 of FIG. 30. Note that the compass icon 2612 is replaced by a book icon 3012 along the left-hand side. If the end user 284 wants to leave the graphical lesson and return to the book, he or she can activate the book icon 3012. At the end of the lesson, a ring (not shown) around the book icon flashes. This can instruct the end user 284 to return to the book.

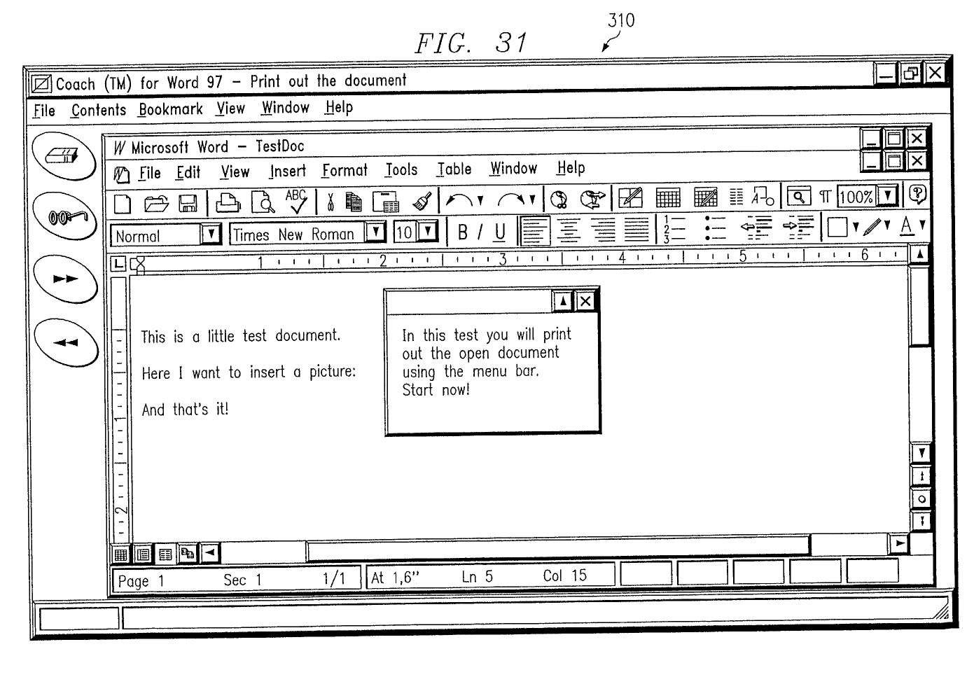

When the end user 284 returns to the book, he or she can be tested on what he or she learned. The text within FIG. 29 briefly describes what acts the end user 284 will perform during the exercise. The end user 284 can activate the nuts or “Test me” symbol 2904 in FIG. 29. View 310 in FIG. 31 includes the first part of the test. If the end user 284 performs the first act properly, the exercise continues with the next view or views (not shown), if any. If the end user 284 is successful, a test report (not shown) can be displayed. The end user 284 can return to the book by activating the book icon 3012. If the end user 284 makes a mistake, the system 10 can request whether the end user 284 needs assistance. If the end user 284 does not want assistance, he or she can reply “no” and continue. Otherwise, the end user 284 may be instructed what action or actions to perform to go to the next part of the test. A test may be stopped by activating the book icon 3012 in FIG. 30. A pop-up screen can appear requesting confirmation to stop the test and return to the book. If “no,” end user 284 returns to the test. Otherwise, the end user 284 returns to the book.

The end user 284 can try to perform a function with assistance from a soft guide 2646, which is more of a quick graphical reference that can be used while the target software program is running. The end user 284 can activate the banana or “Try me” symbol 2906 within FIG. 29 to start the soft guide within the tutor. The end user 284 is displayed view 320 in FIG. 32. When the symbol 2906 is activated, a copy of the target software program is accessed or launched and a file (document) called “Testdoc” for that target software application is opened in portion 3202 in this specific example. Therefore, both the soft guide 2646, which is a file used with a software program (tutor 2642), and the target software program (Word 97) are accessed and running. The soft guide 2646 appears near the bottom right-hand comer of the view 320. The soft guide 2646 typically occupies no more than approximately 50% of the total view seen at monitor 142, and more often occupies no more than 25% of the total view seen at monitor 142.

The soft guide 2646 includes information to help guide the end user 284 in using the target software application. The soft guide 2646 is kept at the highest foreground level similar to conventional help screens that are integrated within many software programs, such as the help screens within Microsoft Word 97™. With the soft guide 2646, the end user 284 may move back and forth between the target software program and the soft guide 284 by using the electronic pointing device 146.

The end user 284 may progress through the soft guide 2646 by using next icon 3222 or the previous icon 3224. The hotspot that was created in the lesson designer had a hand with a graphical pointer and is replaced by the arrow 3226 in the soft guide 2646. Some text appears with the soft guide within text box 3242 in FIG. 32. The text within the text box typically is no greater than about 30 words of basic information related to screenshot (view) 3244. However, more words may be used but may be limited by the amount of text that can be fit into the box. When in the lesson designer interface, the text within the text box 3242 can be edited by using the text box 36 as seen in FIG. 3.

If the end user 2646 desires more detailed information regarding screenshot 3244, he or she can activate the “More text” icon 3228. The detailed information can be seen in the pop-up screen 332 in the view 330 of FIG. 33. The text for pop-up screen comes from the text box (panel)1402 in FIG. 14. The end user 284 can close the pop-up screen by activating the “Hide text” icon 3328. When closed, the end user 284 returns to view 320 in FIG. 32. Alternatively, the text within the pop-up screen 332 can replace the screenshot 3244 if the end user 284 moves the pointer for the electronic pointing device 146 over the screenshot 3244. The end user 284 may enlarge screenshot 3244 by double clicking on it with the electronic pointing device 146. If desired, the end user 284 may reposition the soft guide 2646 by clicking and dragging to the desired location.

In another embodiment, a method of using the soft guide 2646 can be very beneficial to the end user 284 if he or she wants to see how to perform a function without constantly having to use the electronic pointing device 146 when moving between the target software program and the soft guide 2646. In one embodiment, the end user 284 can progress forward or backward by using keys on keyboard 144 and without having to use the icons 3222 or 3224 in FIG. 32.

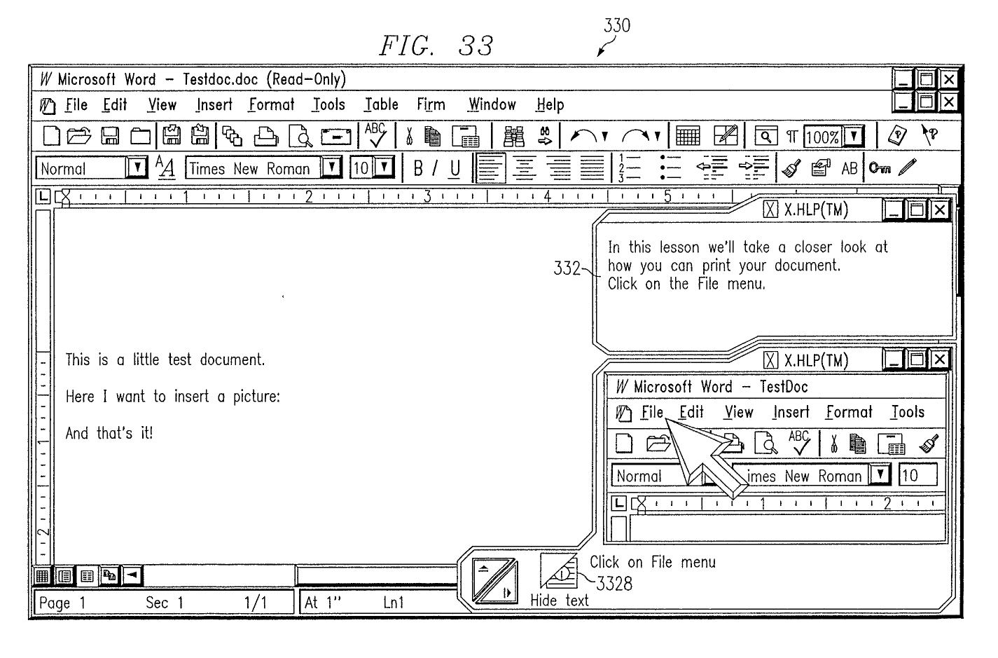

The CTRL key can be used to progress through the soft guide 2646. The code for the soft guide 2646 is designed so that its use should not interfere with the normal operation of the targeted software program. FIG. 34 includes a timing diagram when the CTRL key is used to move to the next page of the soft guide. Because the CTRL key is used by the target software program, the activation of the signal to advance is delayed until the release of the control key. In FIG. 34, activity within the target software program, the soft guide 2646, the letter “P” and CTRL keys on the keyboard 144 are illustrated. Note that activity within the soft guide 2646 begins after the CNTL key is released if no other active keys or function keys on the keyboard 144 are pressed.

Compare FIG. 34 with FIG. 35, in which a key combination is used to activate a function within the target software program. CTRL+P can be used to start the printing function within Microsoft Word 97™. The CTRL key is held down while the “P” letter on the keyboard 144 is pressed. This starts the printing function. Note that the use of CTRL with the letter “P” does not activate the soft guide 2646 because the instructions that are within the code of the soft guide effectively instruct the processor 122 not to advance the soft guide if CTRL and a letter key combination is used. The end user 284 can hold down the SHIFT key and press and release the CTRL key (SHIFT+CTRL) to progress backwards through the soft guide 2646. Similar to advancing, the backward movement does not start until the CTRL key is released.

Some of the activities shown in FIGS. 34 and 35 can be changed. For example, the actions of the target software program may start the printing function on the rising edge of the signal for “P,” and the soft guide may start to progress to the next page on the falling edge of the signal for the CTRL key. Note that the timing diagrams are not necessarily drawn to scale.

In alternate embodiments, other keys or key combinations can be used. For example, ALT could be used instead of CTRL for some operating systems other than Windows. In many embodiments, a system key or a combination of a system key with another key may be used. In still other embodiments, the electronic pointing device 146 may be used. For example, just activating a feature (e.g., pad, scroll bar, or the like) on the electronic pointing device 146 or simple movement of the pointer for the electronic pointing device can be used. The activation of the feature or the simple movement does not require positioning the pointer to any specific location.

The ability to use soft guide 284 while performing functions within the target software program allows training while using the target software program to produce work product in real time. The end user 284 can start a printing function (performing a first act) using Microsoft Word 97™ and advance the soft guide 2646 (performing a second act) while Microsoft Word 97™ resides in an active window.

When the end user 284 is done with the soft guide 284, he or she can close the soft guide 2646 by activating the close icon 3246 within FIG. 32. Alternatively, the end user 284 may minimize the soft guide 2646 by activating the minimize icon 3248.

The use of the microguide 2644 is substantially the same as the soft guide 2646 from the perspective of the end user 284. The use of the web tutor 2622 and web guide 2624 may be substantially the same or similar to the soft tutor 2642 and soft guide 2646, respectively. The end user 284 may progress forwards or backwards by using the conventional forward icon or backward icon that is present within a conventional browser, such as Microsoft Internet Explorer™, Netscape Navigator™, and the like. Unlike the soft guide 2646, the web guide 2624 may not allow simultaneous use of the target software program and the web guide 2624. In this embodiment, the end user 282 will choose whether web guide 2624 or the target software program is currently active.

The development tool and the electronic training guides have code that is external to the target software program. Also, other than screen captures, the development tool and the electronic training guides can be run independently from the target software program. This allows custom electronic training guides that can be updated without having to change the code of the target software program.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method of creating an electronic training guide for using a first software program comprising:
capturing a first screen from the first software program using a second software program to form a first screenshot;
adding text corresponding to the first screenshot, wherein text is added using the second software program; and
assembling the electronic training guide using the second software program, wherein the electronic training guide:
includes at least part of the first screenshot and corresponding text; and
is at least part of a third software program or a file that can be used with the third software program.

2. The method of claim 1, further comprising capturing additional screens from the first software program to form additional screenshots, wherein the additional screens are captured in an order a user of the first software program would see if performing a task using the first software program.

3. The method of claim 1, wherein assembling includes compiling a file including the at least part of the first screenshot and corresponding text to create an executable file.

4. The method of claim 1, further comprising adding a keyword associated with the first screen.

5. The method of claim 1, further comprising adding a related topic that is related to but different from a task associated with the first screen.

6. The method of claim 1, further comprising reviewing a lesson using a data processing system, wherein:
the lesson includes the at least part of the first screenshot and the corresponding text; and
the lesson is reviewed using the second software program.

7. The method of claim 1, wherein:
the first screenshot and corresponding text are parts of a lesson; and
assembling further comprises:
reading a lesson design file to obtain information used to link different parts of the lesson to each other; and
compiling the lesson design file to form a runtime file for the lesson.

8. The method of claim 1, further comprising:
extracting a keyword from the text; and
compiling the keyword into a keyword file.

9. The method of claim 1, wherein assembling further comprises creating a file with data to build a menu and a related topic.

10. The method of claim 9, wherein assembling further comprises embedding information from a style file into the corresponding executable file.

11. The method of claim 1, further comprising adding a user-defined action to a file including the at least part of the first screenshot.

12. The method of claim 1, wherein the electronic training guide is external to and can be run independently from the first software program.

13. The method of claim 1, wherein assembling further comprising reading a style file to obtain information related to an appearance as seen by a user of the electronic training guide.

14. The method of claim 13, wherein the appearance is related to a background view, an icon, and how a transition between views is presented.

15. A method of creating electronic training guides for a first software program comprising:
recording a screenshot from a screen of the first software program; and
creating at least two different electronic training guides using the screenshot, wherein:
the at least two different training guides pertain to a single topic; and
the different electronic training guides are selected from a first lesson, a second lesson that is different from the first lesson, a test, and an executable file.

16. The method of claim 15, wherein creating includes creating only the first lesson and the second lesson.

17. The method of claim 15, wherein creating includes creating only the first lesson, the second lesson, and the test.

18. The method of claim 15, wherein creating includes creating only the first lesson, the second lesson, and the executable file.

19. The method of claim 15, wherein creating includes creating the first lesson, the second lesson, the test, and the executable file.

20. The method of claim 15, wherein:
creating further comprises:
creating the first lesson; and
creating the second lesson after creating the first lesson; and
the first lesson and the second lesson are directed to performing the same task using the first software program.

21. The method of claim 20, wherein:
creating further comprises creating the executable file after creating the first lesson; and
the first lesson and the executable file are directed to performing the same task using the first software program.

22. The method of claim 15, wherein:
the first lesson has a first amount of text;
the second lesson has a second amount of text; and
the first amount is larger than the second amount.

23. A method of guiding a user in using a first software program comprising:
accessing a second software program, wherein the second software program includes information to help guide the user to perform an operation using the first software program; and
displaying a sequence of views using the second software program, wherein:
the sequence of views are in an order in which acts would be performed if using the first software program; and
each view within the sequence of views includes at least a portion of a corresponding view within the first software program, wherein the view within the sequence of views is substantially the same as the at least a portion of the corresponding view in the first software program.

24. The method of claim 23, further comprising accessing the first software program while a view from the second software program is visible.

25. The method of claim 23, wherein each view includes no more than approximately 30 words of basic information related to that view.

26. The method of claim 23, further comprising displaying detailed information related to the corresponding view.

27. The method of claim 26, wherein the detailed information replaces its corresponding view within the sequence of views.

28. The method of claim 26, wherein the detailed information appears within a pop-up screen.

29. The method of claim 23, further comprising pressing and releasing a keyboard key for the user to progress through the sequence of views.

30. The method of claim 23, further comprising activating a feature of an electronic pointing device for the user to progress through the sequence of views.

31. The method of claim 23, further comprising moving a pointer of the electronic pointing device without requiring the pointer to point to any specific location for the user to progress through the sequence of views.

32. The method of claim 23, wherein the second software program is external to and can be run independently from the first software program.

33. The method of claim 23, wherein the second software program automatically progresses in response to an activity by the user while the first software program is active.

34. A method of training a user of a first software program comprising:
accessing a second software program including a test to test the user's ability to perform at least one operation of the first software program; and
taking the test for the at least one operation, wherein:
at least one view is displayed to the user during the test and is substantially similar to at least one corresponding view in the first software program; and
during the test, the user performs substantially the same acts as the user would if performing the at least one operation using the first software program.

35. The method of claim 34, wherein:
taking the test includes producing an incorrect answer; and
in response to the incorrect answer, the second software program displays a view requesting whether the user needs assistance.

36. The method of claim 34, wherein, for at least one of the substantially the same acts, the second software program does not instruct the user how to perform that act.

37. The method of claim 34, wherein the second software program is external to and can be run independently from the first software program.

38. A method of guiding a user in using a first software program comprising:
accessing a first software program;
accessing a second software program, wherein the second software program includes information to help guide the user in using the first software program;
performing a first act using the first software program; and
performing a second act using the second software program while the first software program resides in an active window.

39. The method of claim 38, wherein performing the second act comprises pressing and releasing a key.

40. The method of claim 39, wherein the key is a system key.

41. The method of claim 39, wherein the key is a CTRL key.

42. The method of claim 39, wherein the key is an ALT key.

43. The method of claim 38, wherein performing the second act comprises activating a feature on an electronic pointing device.

44. The method of claim 43, wherein the second act includes moving a pointer of the electronic pointing device without requiring the pointer to point to any specific location to progress through the sequence of views.

45. The method of claim 38, further comprising pressing at least two of the system keys to display detailed information related to the second act.

46. The method of claim 38, wherein the second software program is external to and can be run independently from the first software program.

47. A data processing system readable storage medium having code embodied therein, the code including instructions executable by a data processing system, wherein the instructions are configured to cause the data processing system to perform a method of creating an electronic training guide for using a first software program, the method comprising:
in response to a first signal, capturing a first screen from the first software program to form a first screenshot;
in response to a second signal, adding text corresponding to the first screenshot, wherein text is added to a first file; and
in response to a third signal, assembling the electronic training guide, wherein the electronic training guide:
includes at least part of the first screenshot and corresponding text; and
is at least part of a second software program or a guide file that can be used with the second software program.

48. The data processing system readable storage medium of claim 47, wherein the method further comprises, in response to fourth signals, capturing additional screens from the first software program to form additional screenshots, wherein the additional screens are captured in an order a user of the first software program would see if performing a task using the first software program.

49. The data processing system readable storage medium of claim 47, wherein assembling includes compiling the first file that includes the at least part of the first screenshot and corresponding text to create an executable file.

50. The data processing system readable storage medium of claim 47, wherein the method further comprises, in response to a fourth signal, adding a keyword to the first file, wherein the keyword is associated with the first screen.

51. The data processing system readable storage medium of claim 47, wherein the method further comprises, in response to a fourth signal, adding a related topic to the first file, wherein the related topic is related to but different from a task associated with the first screen.

52. The data processing system readable storage medium of claim 47, wherein the method further comprises displaying a lesson as it would appear to a user of the electronic training guide, wherein the lesson includes the first screenshot and the corresponding text.

53. The data processing system readable storage medium of claim 47, wherein:
the first screenshot and corresponding text are parts of a lesson; and
assembling further comprises:
reading the first file to obtain information used to link different parts of the lesson to each other; and
compiling the first file to form a second file that is a runtime file for the lesson.

54. The data processing system readable storage medium of claim 47, wherein the method further comprises:
extracting a keyword from the text; and
compiling the keyword into a second file.

55. The data processing system readable storage medium of claim 47, wherein assembling further comprises compiling the first file for a lesson to form a second file that is a corresponding runtime file.

56. The data processing system readable storage medium of claim 55, wherein assembling further comprises embedding information from a third file that includes style information into the second file.

57. The data processing system readable storage medium of claim 47, wherein the method further comprises, in response to a fourth signal, adding a user-defined action to the first file.

58. The data processing system readable storage medium of claim 47, wherein the electronic training guide is external to and can be run independently from the first software program.

59. The data processing system readable storage medium of claim 47, wherein assembling further comprises reading a second file to obtain information related to an appearance as seen by a user of the electronic training guide.

60. The data processing system readable storage medium of claim 59, wherein the appearance is related to a background view, an icon, or how a transition between views is presented.

61. A data processing system readable storage medium having code embodied therein, the code including instructions executable by a data processing system, wherein the instructions are configured to cause the data processing system to perform a method of creating electronic training guides for a first software program, the method comprising:
in response to a first signal, recording a screenshot from a screen of the first software program; and
in response to second signals, creating at least two different electronic training guides using the screenshot, wherein:
the at least two different training guides pertain to a single topic; and
the different electronic training guides are selected from a first lesson, a second lesson that is different from the first lesson, a test, and an executable file.

62. The data processing system readable storage medium of claim 61, wherein creating includes creating only the first lesson and the second lesson.

63. The data processing system readable storage medium of claim 61, wherein creating includes creating only the first lesson, the second lesson, and the test.

64. The data processing system readable storage medium of claim 61, wherein creating includes creating only the first lesson, the second lesson, and the executable file.

65. The data processing system readable storage medium of claim 61, wherein creating includes creating the first lesson, the second lesson, the test, and the executable file.

66. The data processing system readable storage medium of claim 61, wherein:
creating further comprises creating the second lesson after creating the first lesson; and
the first lesson and the second lesson are directed to performing the same task using the first software program.

67. The data processing system readable storage medium of claim 66, wherein:
creating further comprises creating the executable file after creating the first lesson; and
the first lesson and the executable file are dfrected to performing the same task using the first software program.

68. The data processing system readable storage medium of claim 61, wherein:
the first lesson has a first amount of text;
the second lesson has a second amount of text; and
the first amount is larger than the second amount.

69. A data processing system readable storage medium having code embodied therein, the code including instructions executable by a data processing system, wherein the instructions are configured to cause the data processing system to perform a method of guiding a user in using a first software program, the method comprising:
in response to a first signal from the user, accessing the code that includes information to help guide the user to perform an operation using the first software program; and
displaying a sequence of views, wherein:
the sequence of views are in an order in which acts would be performed if using the first software program; and
each view within the sequence of views includes at least a portion of a corresponding view within the first software program, wherein the view within the sequence of views is substantially the same as the at least a portion of the corresponding view in the first software program.

70. The data processing system readable storage medium of claim 69, wherein displaying can be performed such that a view from the sequence of views is visible while the first software program is displayed to the user.

71. The data processing system readable storage medium of claim 69, wherein a view within the sequence of views includes no more than approximately 30 words of basic information related to that view while the first software program is displayed to the user.

72. The data processing system readable storage medium of claim 69, wherein the method further comprises, in response to a second signal, displaying detailed information related to the corresponding view.

73. The data processing system readable storage medium of claim 72, wherein during displaying, the detailed information replaces its corresponding view within the sequence of views.

74. The data processing system readable storage medium of claim 72, wherein during displaying, the detailed information appears within a pop-up screen.

75. The data processing system readable storage medium of claim 69, wherein displaying is performed in response to a signal that a user has pressed and released a keyboard key for the user to progress through the sequence of views.

76. The data processing system readable storage medium of claim 69, wherein displaying is performed in response to a signal that a user has activated a feature of an electronic pointing device for the user to progress through the sequence of views.

77. The data processing system readable storage medium of claim 69, wherein displaying is performed in response to a signal that a user has moved a pointer of the electronic pointing device without requiring the pointer to point to any specific location for the user to progress through the sequence of views.

78. The data processing system readable storage medium of claim 69, wherein the code is external to and can be run independently from the first software program.

79. The data processing system readable storage medium of claim 69, wherein the code allows for automatically progressing in response to an activity by a user while the first software program is active.

80. A data processing system readable storage medium having code embodied therein, the code including instructions executable by a data processing system, wherein the instructions are configured to cause the data processing system to perform a method of training a user of a first software program, the method comprising:
in response to a first signal from the user, accessing a test within the code to test the user's ability to perform at least one operation of the first software program; and
giving the test for the at least one operation, wherein:
while giving the test, at least one view is displayed to the user and is substantially similar to at least one corresponding view in the first software program; and
while giving the test, the user is to perform substantially the same acts as the user would if performing the at least one operation using the first software program.

81. The data processing system readable storage medium of claim 80, wherein the method further comprises:
receiving an incorrect answer from the user; and
in response to the incorrect answer, displaying a view requesting whether the user needs assistance.

82. The data processing system readable storage medium of claim 80, wherein, for at least one of the substantially the same acts, the code does not instruct the user how to perform that act.

83. The data processing system readable storage medium of claim 80, wherein the code is external to and can be run independently from the first software program.

84. A data processing system readable storage medium having code embodied therein, the code including instructions executable by a data processing system, wherein the instructions are configured to cause the data processing system to perform a method of guiding a user in using a first software program, the method comprising:
in response to a first signal, accessing the code, wherein the code includes information to help guide the user in using the first software program; and
in response to a second signal, performing a function while the first software program resides in an active window.

85. The data processing system readable storage medium of claim 84, wherein the second signal that corresponds to a user pressing and releasing a key.

86. The data processing system readable storage medium of claim 85, wherein the key is a system key.

87. The data processing system readable storage medium of claim 85, wherein the key is a CTRL key.

88. The data processing system readable storage medium of claim 85, wherein the key is an ALT key.

89. The data processing system readable storage medium of claim 84, wherein the second signal that corresponds to a user activating a feature on an electronic pointing device.

90. The data processing system readable storage medium of claim 89, wherein the second signal that corresponds to a user moving a pointer of the electronic pointing device without requiring the pointer to point to any specific location to progress through the sequence of views.

91. The data processing system readable storage medium of claim 84, wherein the method further comprises, in response to a third signal that corresponds to a user pressing at least two of the system keys, displaying detailed information related to the second signal.

92. The data processing system readable storage medium of claim 84, wherein the code is external to and can be run independently from the first software program.

93. A software program product for creating an electronic training guide for using a first software program, the software program product comprising:
a screen capture module adapted to capture a screen seen when using the first software program;
an editor module adapted to add text related to the captured screen; and
an assembly module adapted to assemble the captured screen and text to form at least part of a second software program or a file that can be used with the second software program.

94. The software program product of claim 93, wherein the second software program include guidance for using the first software program.

95. The software program product of claim 93, further comprising a compression module.

96. The software program product of claim 93, wherein the assembly module includes a compiler.

97. The software program product of claim 93, wherein the second software program include an executable file.

98. The software program product of claim 93, wherein the second software program does not include an executable file.

99. The software program product of claim 93, wherein the second software program of the file includes a tutor and at least one of a soft guide and test.

100. The software program product of claim 93, further comprising a user interaction editor module.

101. The software program product of claim 93, further comprising a style editor module.
